(19) United States
(12) Patent Application Publication
(10) Pub. No.: US 2012/0164272 A1
(43) Pub. Date: Jun. 28, 2012

(54) BAKING ENZYME COMPOSITION AS SSL REPLACER

(75) Inventors: Caroline Hendrine Maria Van Benschop, Rijswijk (NL); Arie Gerrit Terdu, Strijen (NL); Jan Dirk Rene Hille, Wouw (NL)

(73) Assignee: DSM IP ASSTES B.V., Heerlen (NL)

(21) Appl. No.: 13/389,941

(22) PCT Filed: Sep. 2, 2010
(86) PCT No.: PCT/EP10/62834

§ 371 Date: Mar. 15, 2012

(30) Foreign Application Priority Data
Sep. 3, 2009 (EP) 09169407.5
Nov. 17, 2009 (EP) 09176237.7

(51) Int. Cl. A21D 8/04; A21D 13/00; A21D 10/00

(52) U.S. Cl. 426/20; 426/63; 426/64; 426/18; 426/62; 426/549

(57) ABSTRACT

The present invention relates to a baking enzyme composition comprising a lipolytic enzyme having activity on triglycerides, phospholipids and galactolipids, a triacyl glycerol lipase, and preferably at least another enzyme selected from a hemicellulase or cellulase and an amyloglucosidase which can be used to fully replace SSL and/or CSL or other emulsifiers in dough and baked products. The dough in which the baking enzyme composition is added in an effective amount and baked product obtained therefrom have improved properties such as excellent dough stability and shock resistance, and improved volume, crumb structure and crumb softeness of the baked product as well as improved anti staling.

### FIELD OF THE INVENTION

The present invention relates to new baking enzyme compositions, to doughs produced by using said compositions and to baked products obtained therefrom. The present invention also relates to the use of the new baking enzyme composition to replace SSL or CSL in the production of dough or baked product obtained therefrom.

### BACKGROUND OF THE INVENTION

In order to improve the handling properties of a dough and/or the final properties of a baked product there is a continuous effort to develop processing aids with improving properties. Processing aids are defined herein as compounds that improve the handling properties of the dough and/or the final properties of the baked products. Dough properties that may be improved comprise stability, machineability, gas retaining capability, reduced stickiness, elasticity, extensibility, moldability etcetera. Properties of the baked products that may be improved comprise loaf volume, crust crispiness, reduced blistering, crumb structure, crumb softness, flavour, relative staleness and shelf life. These dough and/or baked product improving processing aids can be divided into two groups: chemical additives and enzymes (also referred to as baking enzymes).

Chemical additives with improving properties comprise oxidising agents such as ascorbic acid, bromate and azodicarbonate, reducing agents such as L-cysteine and glutathione, emulsifiers acting as dough conditioners such as diacetyl tartaric acid esters of mono/diglycerides (DATEM), sodium stearoyl lactylate (SSL) or calcium stearoyl lactylate (CSL), or acting as crumb softeners such as glycerol monostearate (GMS) etceteras, fatty materials such as triglycerides (fat) or lecithin and others.

Emuslifiers, applied in baking industry can be roughly divided in crumb softening or dough strengthening agents. Distilled monoglycerides are used mainly for crumb softening. Complexing of the monoglycerides with starch prevents complete recrystallisation of starch, which results in initial crumb softness and/or reduction of crumb firming rate during shelf life of the baked product. For dough strengthening, a few different synthetic analogues of polar lipids are applied, such as DATEM, CSL and SSL. Their effect in breadmaking is mainly to improve dough stabitiliy.

Also other dough characteristics such as reduced stickiness of the dough, improved machinability of the dough, and improved characteristis of the baked product such as increased loaf volume, improved crumb structure, improved crumb softness and shelf life and improved crispiness of the crust can be reached.

While DATEM is mainly used as chemical emulsifier in crusty, loaf type of bread, SSL or CSL find their main application in soft bread such as tin bread, sandwich bread and soft roll buns.

As a result of a consumer-driven need to replace the chemical additives by more natural products, several baking enzymes are being developed with dough and/or baked product improving properties depending on the specific baking application conditions.

The resistance of consumers to chemical additives is growing and there is therefore constant need to replace emulsifiers by consumer friendly additives and/or enzymes, which are considered as processing aids. However, bread quality is lowered considerably when emulsifiers are omitted, for example, it is difficult to achieve a shelf life of 3 to 5 days for non-crusty types of bread such as sandwich breads without using emulsifiers like SSL or monoglycerides.

Studies on bread staling have indicated that the starch fraction in bread recrystallizes during storage, thus causing an increase in crumb firmness. Amylases and hemicellulases are widely used in bread improvers to improve crumb softness and loaf volume. α-Amylases partially degrade the starch fraction during baking and increase crumb softness. Hemicellulases break down the hemicellulose fraction of wheat flour, thus releasing water normally bound to this fraction into the dough. The use of hemicellulases in bread improvers results in an improved oven spring of the dough during baking, an improved loaf volume, grain structure and better keeping quality of the baked bakery product. However, the combined improvements imparted by amylases and hemicellulases are limited and therefore emulsifiers are still required for obtaining an acceptable keeping quality of bread.

De Maria et al in Appl. Microbiol. Biotechnol. (2007) 74: 290-300 describe that phospholipases may be used in the baking industry, in particular to partially or totally replace emulsifiers such as DATEM, CSL or SSL in the production of baked products.

WO02/03805 describes that the combination of two lipolytic enzymes with different substrate specificity produces a synergistic effect on the dough or baked product made from the dough and yields a baked product with improved volume and/or baked product with better shape retention during baking.

EP0585988 describes a bread improver composition comprising lipase, hemicellulase and amylase, preferably in combination with shortening. The combination of said enzyme preparation and preferably shortening can replace emulsifiers like SSL and monoglycerides.

With the new drive to reduce the use of chemical emulsifiers such as SSL or CSL in the manufacture of baking products, there is a need for alternative or improved baking enzyme compositions which can replace these chemical emulsifiers in the baking process. It is an object of the present invention to provide a new baking enzyme composition which can partially or fully replace emulsifiers, in particular SSL or CSL in the production of dough and the baked product produced therefrom.

### SUMMARY OF THE INVENTION

In a first aspect of the invention a baking enzyme composition is disclosed which comprises a lipolytic enzyme which is an isolated polypeptide comprising:
(a) an amino acid sequence according to the mature polypeptide derived from the amino acid sequence according to SEQ ID NO: 2 or a functional equivalent thereof having an amino acid sequence at least 60, 70, 80 or 90% homologous to the mature polypeptide in the amino acid sequence according to SEQ ID NO: 2; OR
(b) an amino acid sequence encoded by a polynucleotide which comprises:
   (a) the nucleotide sequence as set out in SEQ ID NO: 1 or a functional equivalent thereof having at least 60, 70, 80 or 90% homology to the nucleotide sequence of SEQ ID NO: 1; OR
   (b) a nucleotide sequence which hybridizes with a polynucleotide being the complement of SEQ ID NO: 1 and wherein said nucleotide sequence is at least 60, 70, 80 or 90% homologous to the nucleotide sequence of SEQ ID NO: 1; OR
   (c) a nucleotide sequence encoding the mature polypeptide derived from the amino acid sequence according to SEQ ID NO: 2 or a functional equivalent thereof having at least 60, 70, 80 or 90% homology to the mature polypeptide derived from the amino acid sequence of SEQ ID NO: 2; OR
   (d) a sequence which is degenerate as a result of the degeneracy of the genetic code to a sequence as defined in any one of (a), (b), (c); OR
   (e) a nucleotide sequence which is the complement of a nucleotide sequence as defined in (a), (b), (c), or (d);
      and wherein the composition further comprises a triacyl glycerol lipase, preferably a lipase derived from Rhizopus oryzae.

The baking enzyme composition may further comprise a cellulase or hemicellulase, and an amyloglucosidase or mixture of one or more of these enzymes. The baking enzyme composition according to the present invention may further comprise one or more other enzymes, one or more dough-improving and/or bread improving additives. In a second aspect the invention provides a pre-mix comprising the baking enzyme compostion according to the first aspect of the invention, flour and one or more dough or bread additives.

In another aspect the invention provides a dough comprising flour, water, yeast and a baking enzyme composition or premix according to the invention. It has been surprisingly found that a dough comprising the baking enzyme composition according to the invention has excellent stability, shock resistance against mechanical abuse and other properties such as good extensibility and low stickiness. The use of the baking composition according to the invention eliminates the impact of flour variability by automatically buffering changes to different lipid profiles in the flour due to seasonal variations. In a fourth aspect the present invention provides a baked product obtainable by baking the dough according to the invention. It has also been surprisingly found that the baked product according to the invention may have an improved volume and very good crumb structure, in particular fine crumb structure, crumb softness and therefore increased shelf-life.

In further aspects the invention provides methods to produce the dough and the baked product according to the invention. The invention also provides the use of a baking enzyme composition or pre-mix according to the invention to replace emulsifiers, preferably to replace SSL or CSL, in the production of a dough or baked product derived therefrom. Omision of SSL and/or CSL form the pre-mix leads to a reduction of handling and storage of ingredients during production of the baked product and allows cost reduction due to the fact that the baking composition of the invention can be used at far lower dosages than SSL or CSL.

### DETAILED DESCRIPTION OF THE INVENTION

Therefore in the first aspect of the invention a baking compostion is disclosed comprising a lipolytic enzyme (indicated hereafter as the lypolytic enzyme according to the invention) which is an isolated polypeptide comprising:
(a) an amino acid sequence according to the mature polypeptide derived from the amino acid sequence according to SEQ ID NO: 2 or a functional equivalent thereof having an amino acid sequence at least 60, 70, 80 or 90% homologous to the mature polypeptide derived from the amino acid sequence according to SEQ ID NO: 2; OR
(b) an amino acid sequence encoded by a polynucleotide which comprises:
   (a) the nucleotide sequence as set out in SEQ ID NO: 1 or a functional equivalent thereof having at least 60, 70, 80 or 90% homology to the nucleotide sequence of SEQ ID NO: 1; OR
   (b) a nucleotide sequence which hybridizes with a polynucleotide being the complement of SEQ ID NO: 1 and wherein said nucleotide sequence is at least 60, 70, 80 or 90% homologous to the nucleotide sequence of SEQ ID NO: 1; OR
   (c) a nucleotide sequence encoding the mature polypeptide derived from the amino acid sequence according to SEQ ID NO: 2 or a functional equivalent thereof having at least 60, 70, 80 or 90% homology to the mature polypeptide derived from the amino acid sequence of SEQ ID NO: 2; OR
   (d) a sequence which is degenerate as a result of the degeneracy of the genetic code to a sequence as defined in any one of (a), (b), (c); OR
   (e) a nucleotide sequence which is the complement of a nucleotide sequence as defined in (a), (b), (c), or (d);
and wherein the composition further comprises a triacyl glycerol lipase, preferably a triacyl glycerol lipase derived from Rhizopus oryzae.

The lipolytic enzyme according to the invention used in the baking enzyme composition can act upon several types of lipids, ranging from glycerides (eg. triglycerides), phospholipids, and glycolipids, such as galactolipids, in bakery applications. Preferably the lipolytic enzyme according to the invention has lipolytic activity on triglycerides, phospholipids and galactolipids in bakery applications, e.g. under dough conditions.

The lipolytic enzyme is encoded by a nucleotide sequence having at least 60%, preferably at least 70%, more preferably at least 80% or most preferably 90% homology to the nucleotide sequence of SEQ ID NO: 1 or is the mature polypeptide derived from the amino acid sequence according to SEQ ID NO: 2 or a functional equivalent thereof having at least 60%, preferably at least 70%, more preferably at least 80% or most preferably at least 90% homology to the mature polypeptide derived from the amino acid sequence of SEQ ID NO: 2.

A preferred lipolytic enzyme to be used in the baking composition of the invention is a lipolytic enzyme corresponding to the mature polypeptide derived from amino acid sequence according to SEQ ID NO: 2 (indicated as L01), i.e. amino acids 34-304 in SEQ ID NO: 2, and which amino acid sequence is encoded by the nucleotide sequence of SEQ ID NO: 1.

More specifically the lipolytic enzyme used in the baking enzyme composition according to the invention shows at least one, preferably all of the following properties when used in situ in dough:
a relatively low activity towards apolar lipids.
a relatively high activity towards polar diacyl-lipids, such as diacyl galactolipids and/or phospholipids
a relatively low activity towards polar monoacyl compounds, such as lysogalactolipids and lysophospholipids.

These unexpected properties are all found to be extremely advantageous when used as a replacer of chemical emulsifiers in dough.

Glycerides are esters of glycerol and fatty acids. Triglycerides (also known as triacylglycerol or triacylglycerides) are mostly present in vegetable oils and animal fat. Lipases (also known as triacyl glycerol lipases) (EC 3.1.1.3) are defined herein as enzymes that hydrolyse one or more of the fatty acids present in triglycerides, more specifically they hydrolyse the ester bond between fatty acid and hydroxyl groups of the glycerol moiety.

Glycolipids (e.g. galactolipids) consist of a glycerol backbone with two esterified fatty acids in an outer (sn-1) and middle (sn-2) position, while the third hydroxyl group is bound to sugar residues such as in case of galactolipids a galactose, for example monogalactosyldiglyceride (MGDG) or digalactosyldiglyceride (DGDG). Galactolipase (EC 3.1.1.26) catalyses the hydrolysis of one or both fatty acyl group(s) in the sn-1 and sn-2 positions respectively from a galactosyldiglyceride.

Phospholipids consist of a glycerol backbone with two esterified fatty acids in an outer (sn-1) and the middle (sn-2) position, while the third hydroxyl group of the glycerol is esterified with phosphoric acid. The phosphoric acid may, in turn, be esterified to for example an amino alcohol like ethanolamine (phosphatidylethanolamine), choline (phosphatidylcholine). Phospholipases are defined herein as enzymes that participate in the hydrolysis of one or more bonds in the phospholipids.

Several types of phospholipase activity can be distinguished which hydrolyse the ester bond(s) that link the fatty acyl moieties to the glycerol backbone:
Phospholipase A1 (EC 3.1.1.32) and A2 (EC 3.1.1.4) catalyse the deacylation of one fatty acyl group in the sn-1 and sn-2 positions respectively, from a diacylglycerophospholipid to produce a lysophospholipid. This is a desirable activity for emulsifier replacement.
Lysophospholipase (EC 3.1.1.5—also called phospholipase B by the Nomenclature Committee of the International Union of Biochemistry and Molecular Biology (Enzyme Nomenclature, Academic Press, New York, 1992)) catalyses the hydrolysis of the remaining fatty acyl group in a lysophospholipid. A phospholipase B has been reported from Penicillium notatum (Saito et al., 1991, Methods in Enzymology 197:446-456), which catalyses the deacylation of both fatty acids from a diacylglycerophospholipid and intrinsically possesses lysophospholipase activity. For emulsifier replacement lysophospholipase activity is less desirable, since this would result in deletion of the combination of a polar head and apolar tail, disabling the resulting product to influence surface properties. Surprisingly it was shown that the lipolytic enzyme according to the invention shows relatively low lysophospholipase activity in the dough.

The lypolytic enzyme according to the invention and having activity on triglycerides, phospholipids and galactolipids may be used as such to replace emulsifiers preferably SSL and/or CSL in the dough. When incorporated in an effective amount in a dough, the lipolytic enzyme having activity on triglycerides, phospholipids and galactolipids may improve one or more properties of the dough or of the baked product obtained therefrom relative to a dough or a baked product in which the polypeptide is not incorporated.

The term “improved property” is defined herein as any property of a dough and/or a product obtained from the dough, particularly a baked product, which is improved by the action of the lipolytic enzyme according to the invention or by the baking enzyme composition according to the invention relative to a dough or product in which the lipolytic enzyme or composition according to the invention is not incorporated. The improved property may include, but is not limited to, increased strength of the dough, increased elasticity of the dough, increased stability and increased shock-resistance of the dough, reduced stickiness of the dough, improved extensibility of the dough, improved machineability of the dough, increased volume of the baked product, improved flavour of the baked product, improved crumb structure of the baked product, improved crumb softness of the baked product, reduced blistering of the baked product and/or improved anti-staling of the baked product.

The improved property may be determined by comparison of a dough and/or a baked product prepared with and without addition of the lipolytic enzyme or of the baking enzyme composition of the present invention in accordance with the methods of present invention which are described below. Organoleptic qualities may be evaluated using procedures well established in the baking industry, and may include, for example, the use of a panel of trained taste-testers.

The term “increased strength of the dough” is defined herein as the property of a dough that has generally more elastic properties and/or requires more work input to mould and shape.

The term “increased elasticity of the dough” is defined herein as the property of a dough which has a higher tendency to regain its original shape after being subjected to a certain physical strain.

The term “increased stability of the dough” is defined herein as the property of a dough that is less susceptible to mechanical abuse thus better maintaining its shape and volume and is evaluated by the ratio of height:width of a cross section of a loaf after normal and/or extended proof.

The term “reduced stickiness of the dough” is defined herein as the property of a dough that has less tendency to adhere to surfaces, e.g., in the dough production machinery, and is either evaluated empirically by the skilled test baker or measured by the use of a texture analyser (e.g., TAXT2) as known in the art.

The term “improved extensibility of the dough” is defined herein as the property of a dough that can be subjected to increased strain or stretching without rupture.

The term “improved machineability of the dough” is defined herein as the property of a dough that is generally less sticky and/or more firm and/or more elastic.

The term “increased shock resistance of the dough” is defined herein as the property of the dough of maintaining its shape and volume after undergoing mechanical shock. It is evaluated by determining the percentage of volume variation of a baked product obtained from a shocked dough in comparison with a baked product obtained from an identical dough which did not undergo mechanical shock. A dough is sufficiently stable when the loss in volume of a baked product obtained by a shocked dough if compared to a baked product obtained by an identical dough which has not been shocked is as small as possible or absent. A dough may be shocked by methods known to those skilled in the art, for example with the method reported under the experimental section.

The term “increased volume of the baked product” is measured as the volume of a given loaf of bread determined by an automated bread volume analyser (eg. BVM-3, TexVol Instruments AB, Viken, Sweden), using ultrasound or laser detection as known in the art.

The term “reduced blistering of the baked product” is defined herein as a visually determined reduction of blistering on the crust of the baked bread.

The term “improved crumb structure of the baked product” is defined herein as the property of a baked product with finer cells and/or thinner cell walls in the crumb and/or more uniform/homogenous distribution of cells in the crumb and is usually evaluated visually by the baker or by digital image analysis as known in the art (eg. C-cell, Calibre Control International Ltd, Appleton, Warrington, UK).

The term “improved softness of the baked product” is the opposite of “firmness” and is defined herein as the property of a baked product that is more easily compressed and is evaluated either empirically by the skilled test baker or measured by the use of a texture analyzer (e.g., TAXT2 or TA-XT Plus from Stable Micro Systems Ltd, surrey, UK) as known in the art.

The term “improved flavor of the baked product” is evaluated by a trained test panel.

The term “improved anti-staling of the baked product” is defined herein as the properties of a baked product that have a reduced rate of deterioration of quality parameters, e.g., softness and/or elasticity, during storage.

The term “improved crispiness” is defined herein as the property of a baked product to give a crispier sensation than a reference product as known in the art, as well as to maintain this crispier perception for a longer time than a reference product. This property can be quantified by measuring a force versus distance curve at a fixed speed in a compression experiment using e.g. a texture analyzer TA-XT Plus (Stable Micro Systems Ltd, Surrey, UK), and obtaining physical parameters from this compression curve, viz. (i) force of the first peak, (ii) distance of the first peak, (iii) the initial slope, (iv) the force of the highest peak, (v) the area under the graph and (vi) the amount of fracture events (force drops larger than a certain preset value). Indications of improved crispness are a higher force of the first peak, a shorter distance of the first peak, a higher initial slope, a higher force of the highest peak, higher area under the graph and a larger number of fracture events. A crispier product should score statistically significantly better on at least two of these parameters as compared to a reference product. In the art, “crispiness” is also referred to as crispness, crunchiness or crustiness, meaning a material with a crispy, crunchy or crusty fracture behaviour.

When the lipolytic enzyme according to the invention having activity on triacylglycerides, phospholipids and galactolipids is incorporated as such in a dough in an effective amount, several properties of the dough, such as strength of the dough, and of a baked product obtained therefrom, such as bread volume, may be improved. However these improvements may not be completely sufficient especially when the baked product is of the soft, non crusty type such as tin bread or sandwitch bread, rolls, buns such as hamburger buns or yeast raised doughnuts. Therefore SSL or CSL still needs to be added as an ingredient to the dough to obtain the desired dough- and baked product-characteristics.

It has been surprisingly found that when the lipolytic enzyme according to the invention and a triacyl glycerol lipase are added in effective amounts to a dough used to produce a baked product such as tin bread, a dough with good strength, improved stability and machinability may be obtained while the corresponding baked product may show an improved bread volume and fine crumb structure. A dough comprising an effective amount of the lipolytic enzyme according to the invention and of the triacyl glycerol lipase may have stability properties which are similar to those in which SSL or CSL is incorporated.

The triacyl glycerol lipase is preferably a fungal lipase, preferably derived from Rhizopus, Aspergillus, Candida, Penicillum, Thermomyces, or Rhizomucor. More preferably a triacyl glycerol lipase derived from Rhyzopus, more preferebaly derived from Rhyzopus oryzae is used. Optionally a combination of two or more triacyl glycerol lipases can be used. Therefore in another embodiment of the invention the baking enzyme composition according to the invention further comprises a combination of two or more triacyl glycerol lipases.

In a preferred embodiment of the invention the baking enzyme composition according to the invention further comprises a hemicellulase or cellulase, preferably a cellulase. Optionally a combination of two or more hemicellulase and/or two or more cellulases and/or a combination of one or more hemicellulase with one or more cellulases can be used.

It has been surprisingly found that when a baking composition comprising a lipolytic enzyme according to the invention, a triacyl glycerol lipase and a hemicellulase or cellulase, preferably a cellulase is added in effective amounts to dough used to produce a baked product such as tin bread or sandwich bread, buns such as hamburger buns, rolls and yeast raised doughnuts, the properties of the dough and of the baked product obtained from the dough may be further improved in respect with a dough that comprises a lipolytic enzyme according to the invention and a triacyl glycerol lipase but no hemicellulase or cellulase. In particular a further improved volume and/or finer crumb structure and/or crumb softness may be obtained.

Particularly good results may be obtained using cellulase derived from A. niger or derived from Trichoderma reesei.

In an even more preferred embodiment of the invention the baking enzyme composition according to the invention further comprises an amyloglucosidase, preferably an amyloglucosidase derived from Aspergillus such as from A. oryzae or A. niger, more preferably derived from A. niger.

Surprisingly when a baking enzyme composition comprising the lipolytic enzyme according to the invention, a triacyl glycerol lipase, a hemicellulase or cellulase, preferably a cellulase, and an amyloglucosidase is incorporated to a dough in an effective amount the quality of the dough and of the baked product obtained therefrom may be further improved in respect with a dough that comprises a lipolytic enzyme according to the invention, a triacyl glycerol lipase and hemicellulase or cellulase but no amyloglucosidase. The resulting dough may have exceptional qualities such as improved stability and/or increased shock-resistance, improved machinability, good fluffiness and the corresponding product may have an excellent volume, fine crumb structure and/or crumb softness and as a consequence it may have an extended shelf life. These improvements allow complete substitution of SSL or CSL in the dough.

The baking enzyme composition according to the invention may further comprise additional enzymes and/or dough and/or bread additives.

The additional enzyme may be of any origin, including mammalian and plant, and preferably of microbial (bacterial, yeast or fungal) origin and may be obtained by techniques conventionally used in the art.

The additional enzyme may be an amylase, such as an alpha-amylase (useful for providing sugars fermentable by yeast and retarding staling), beta-amylase, maltogenic amylase or non-maltogenic amylase, a cyclodextrin glucanotransferase, a protease, a peptidase, in particular, an exopeptidase (useful in flavour enhancement), transglutaminase, galactolipase, phospholipase, hemicellulase, such as in particular a pentosanase e.g. xylanase (useful for the partial hydrolysis of pentosans, more specifically arabinoxylan, which increases the extensibility of the dough), protease (useful for gluten weakening in particular when using hard wheat flour), protein disulfide isomerase, e.g., a protein disulfide isomerase as disclosed in WO 95/00636, glycosyltransferase, peroxidase (useful for improving the dough consistency), laccase, or oxidase, hexose oxidase, e.g., a glucose oxidase, aldose oxidase, pyranose oxidase, lipoxygenase or L-amino acid oxidase (useful in improving dough consistency). When the baking composition according to the invention further comprises a maltogenic amylase addition of the composition to the dough leads to a baked product obtained therefrom with improved crumb softness and therefore improved shelf life.

In dough and bread making the baking enzyme composition according to the invention may be used in combination with other bread or dough ingredients or additives such as salt, the chemical processing aids like oxidants (e.g. ascorbic acid), reducing agents (e.g. L-cysteine), and/or emulsifiers (e.g. DATEM, SSL and/or CSL), and/or enzymatic processing aids such as oxidoreductases (e.g. glucose oxidase), polysaccharide modifying enzymes (e.g. α-amylase, hemicellulase, branching enzymes, etc.) and/or protein modifying enzymes (endoprotease, exoprotease, branching enzymes, etc.). Preferably the additives used to manufacture the baked product or the dough do not comprise SSL and/or CSL, more preferably they do not comprise emulsifiers selected from SSL, CSL, DATEM, GMS, more preferably does not comprise emulsifiers.

In a second aspect, the invention provides a pre-mix comprising a baking enzyme composition according to the invention, flour and one or more bread- or dough additives as hereinbefore described.

The term “pre-mix” is defined herein to be understood in its conventional meaning, i.e., as a mix of baking agents, generally including flour, which may be used not only in industrial bread-baking plants/facilities, but also in retail bakeries. The pre-mix may be prepared by mixing the baking enzyme composition of the invention with a suitable carrier such as flour, starch, a sugar, a complex carbohydrate such as maltodextrin, or a salt. The pre-mix may contain other dough and/or bread additives, e.g., any of the additives, including enzymes, mentioned above.

In another aspect the invention discloses a method to prepare a dough comprising adding to dough ingredients comprising at least flour, water and yeast a baking enzyme composition or pre-mix according to the invention.

The preparation of a dough from the ingredients and bread or dough additives described above is well known in the art and comprises mixing of said ingredients and additives and one or more moulding and fermentation steps.

In another aspect, the invention provides a dough comprising flour, water, yeast and an effective amount of a baking enzyme composition or a pre-mix according to the invention.

The present invention also relates to methods for preparing a dough or a baked product comprising incorporating into the dough an effective amount of a baking enzyme composition of the present invention which improves one or more properties of the dough or the baked product obtained from the dough relative to a dough or a baked product in which the polypeptide is not incorporated.

The phrase “incorporating into the dough” is defined herein as adding the baking enzyme composition according to the invention to the dough, any ingredient from which the dough is to be made, and/or any mixture of dough ingredients from which the dough is to be made. In other words, the baking enzyme composition of the invention may be added in any step of the dough preparation and may be added in one, two or more steps. The composition is added to the ingredients of a dough that is kneaded and baked to make the baked product using methods well known in the art. See, for example, U.S. Pat. No. 4,567,046, EP-A-426,211, JP-A-60-78529, JP-A-62-111629, and JP-A-63-258528.

The term “effective amount” is defined herein as an amount of baking enzyme composition according to the invention that is sufficient for providing a measurable effect on at least one property of interest of the dough and/or baked product.

The term “dough” is defined herein as a mixture of flour and other ingredients firm enough to knead or roll. The dough may be fresh, frozen, pre-pared, or pre-baked. The preparation of frozen dough is described by Kulp and Lorenz in “Frozen and Refrigerated Doughs and Batters”, K. Kulp, K. Lorenz, J. Brummer, Editors, American Association of Cereal Chemists, Publisher (1995).

According to a preferred embodiment of the present invention, the lipolytic enzyme according to the invention may be added to a dough in an amount of at least 3.57 DLU units per kg of flour of lipolytic enzyme according to the invention (for example of L01), preferably at least 7.15 DLU/kg flour, more preferably at least 14.30 DLU/kg flour. According to a preferred embodiment of the invention the lipolytic enzyme according to the invention may be added to a dough in an amount of at most 143 DLU/kg flour of lipolytic enzyme according to the invention, preferably at most 71.50 DLU/kg flour, more preferably at most 35.75 DLU/kg flour. The activity of the lipolytic enzyme according to the invention in DLU units can be measured as indicated in Materials and Methods.

According to the present invention the dough further comprises triacyl glycerol lipase. According to a preferred embodiment of the present invention, the triacyl glycerol lipase may be added to a dough in an amount of at least 80 PLI units per kg of flour of triacyl glycerol lipase, preferably at least 160 PLI/kg flour, more preferably at least 320 PLI/kg flour. According to a preferred embodiment of the invention the triacyl glycerol lipase may be added to a dough in an amount of at most 3200 PLI/kg flour of triacyl glycerol lipase, preferably at most 1600 PLI/kg flour, more preferably at most 800 PLI/kg flour. The activity of the triacyl glycerol lipase in PLI units can be measured as indicated in Materials and Methods.

The dough according to the invention may further comprise cellulase. According to a preferred embodiment of the present invention, the cellulase may be added to a dough in an amount of at least 2.34 CXU units per kg of flour of cellulase, preferably at least 4.68 CXU/kg flour, more preferably at least 7.5 CXU/kg flour, even more preferably at least 9.36 CXU/kg flour, even more preferably at least 15 CXU/kg flour, most preferably at least 23.4 CXU/kg of flour. According to a preferred embodiment of the invention the cellulase may be added to a dough in an amount of cellulase of at most 300 CXU/kg of flour, preferably in an amount of at most 150 CXU/kg of flour, more preferably at most 93.6 CXU/kg flour, even more preferably at most 75 CXU/kg of flour, even more, preferably at most 46.8 CXU/kg flour, most preferably at most 30 CXU/kg flour. The activity of the cellulase in CXU units can be measured as indicated in Materials and Methods.

According to the present invention the dough may further comprise amyloglucosidase. According to a preferred embodiment of the amyloglucosidase may be added to a dough in an amount of at least 130 AGI units per kg of flour of amyloglucosidase, preferably at least 260 AGI/kg flour, more preferably at least 520 AGI/kg flour. According to a preferred embodiment of the invention the amyloglucosidase may be added to a dough in an amount of at most 5200 AGI/kg flour of amyloglucosidase, preferably at most 2600 AGI/kg flour, more preferably at most 1300 AGI/kg flour. The activity of the amyloglucosidase in AGI units can be measured as indicated in Materials and Methods.

In a preferred embodiment the dough according to the present invention is substantially free of SSL and/or CSL, preferably it is substantially free of emulsifiers selected from SSL, CSL, DATEM, GSM, more preferably it is free of emulsifiers. In general the amount of SSL and/or CSL that is normally used in dough is 0.1-0.5% w/w based on flour present in the dough. The baking composition according to the invention especially when added to the dough in the amounts mentioned above may fully replace the above-mentioned amounts of SSL or CSL present in the dough. In applications where SSL is primarily used as a crumb softener and anti-staling agent, and no other softening systems are added to the bread making process, a benefit can be achieved by using the baking enzyme composition according to the invention in combination with maltogenic amylase and it may be useful to use 1-2 ppm of maltogenic amylase for each 0.1% SSL replaced.

In a further aspect the invention provides a method to prepare a baked product comprising the steps of baking a dough according to the invention.

The invention also provides a baked product obtainable by baking a dough according to the invention.

The preparation of baked products from such doughs is also well known in the art and may comprise moulding and shaping and further fermentation of the dough followed by baking at required temperatures and baking times. In one embodiment the invention provides a method to prepare a baked product comprising the step of baking the dough according to the invention. The invention also provides a baked product obtainable according to this method. Preferably the baked product according to the invention is bread, more preferably the baked product is of a soft character such as tin bread, sandwich bread, a bun or a roll.

The term “baked product” is defined herein as any product prepared from a dough, either of a soft or a crisp character. Preferably the baked product is of a soft character, preferably a bread of soft character such as a tin bread, a sandwitch bread, a bun or a roll. Further examples of baked products, whether of a white, light or dark type, which may be advantageously produced by the present invention are bread (in particular white, whole-meal or rye bread), typically in the form of loaves or rolls, French baguette-type bread, pastries, croissants, pasta, noodles (boiled or (stir-)fried), pita bread, tortillas, tacos, cakes, muffins, pancakes, biscuits, cookies, doughnuts, bagles, pie crusts, steamed bread, and crisp bread, and the like.

The invention further provides the use of a baking composition or a pre-mix according to the invention to replace SSL or CSL, preferably to replace emulsifiers selected from SSL, CSL, DATEM, GMS, preferably to replace all emulsifiers in the production of a dough or a baked product derived therefrom.

Hereafter the lipolytic enzyme according to the invention having activity on triacyl glycerides, phospholipids and galactolipids in bakery application is further described as well as the polynucleotides encoding for the lipolytic enzyme (indicated hereafter as polynucleotides according to the invention).

The polynucleotide according to the invention comprises a nucleotide sequence selected from:
(a) the nucleotide sequence as set out in SEQ ID NO: 1 or a functional equivalent thereof having at least 60, 70, 80 or 90% homology to the nucleotide sequence of SEQ ID NO: 1;
(b) a nucleotide sequence which hybridizes with a polynucleotide being the complement of SEQ ID NO: 1 and wherein said sequence is at least 60, 70, 80 or 90% homologous to the nucleotide sequence of SEQ ID NO: 1;
(c) a nucleotide sequence encoding the mature polypeptide in the amino acid sequence according to SEQ ID NO: 2 or a functional equivalent thereof having at least 60, 70, 80 or 90% homology to the mature polypeptide in the amino acid sequence of SEQ ID NO: 2;
(d) a sequence which is degenerate as a result of the degeneracy of the genetic code to a sequence as defined in any one of (a), (b), (c);
(e) a nucleotide sequence which is the complement of a nucleotide sequence as defined in (a), (b), (c), (d).

In particular, the invention provides for polynucleotides having a nucleotide sequence that hybridizes preferably under high stringent conditions with a polynucleotide being the complement of SEQ ID NO: 1 and wherein said sequence is at least 60, 70, 80 or 90% homologous to the nucleotide sequence of SEQ ID NO: 1. Consequently, the invention provides polynucleotides that are at least 90%, preferably at least 91%, more preferably at least 92%, 93%, 94%, 95%, even more preferably at least 96%, 97%, 98% or 99% homologous to the sequence according to SEQ ID NO: 1.

In one embodiment such isolated polynucleotide can be obtained synthetically, e.g. by solid phase synthesis or by other methods known to the person skilled in the art.

In another embodiment the invention provides a lipolytic enzyme gene according to SEQ ID NO: 1 or functional equivalents that are still coding for the active lipolytic enzyme.

Preferably the polynucleotide according to the invention is a DNA sequence.

The invention also relates to vectors comprising a polynucleotide sequence according to the invention and primers, probes and fragments that may be used to amplify or detect the DNA according to the invention.

In a further preferred embodiment, a vector is provided wherein the polynucleotide sequence according to the invention is operably linked with at least one regulatory sequence allowing for expression of the polynucleotide sequence in a suitable host cell. Preferably said suitable host cell is a filamentous fungus, more preferably Aspergillus species. Suitable strains belong to Aspergillus niger, oryzae or nidulans. Preferably the host cell is Aspergillus niger.

The invention also relates to recombinantly produced host cells that contain polynucleotides according to the invention.

The invention also provides methods for preparing polynucleotides and vectors according to the invention.

In another embodiment, the invention provides recombinant host cells wherein the expression of a polynucleotide according to the invention is significantly increased or wherein the production level of lipolytic activity is significantly improved.

In another embodiment the invention provides for a recombinantly produced host cell that contains heterologous or homologous DNA according to the invention and wherein the cell is capable of producing a functional lipolytic enzyme according to the invention, i.e. it is capable of expressing or preferably over-expressing a polynucleotide encoding for the lipolytic enzyme according to the invention, for example an Aspergillus strain comprising an increased copy number of a gene according to the invention.

In yet another aspect of the invention, an isolated polypeptide having lipolytic acitivity is provided. The polypeptides according to the invention comprises an amino acid sequence selected from:

(a) an amino acid sequence according to the mature polypeptide derived from the amino acid sequence according to SEQ ID NO: 2 or a functional equivalent thereof having an amino acid sequence at least 60, 70, 80 or 90% homologous to the mature polypeptide derived from the amino acid sequence according to SEQ ID NO: 2.

In one embodiment the invention also relates to an isolated polypeptide having lipolytic activity which is a functional equivalent of the mature polypeptide derived from the amino acid sequence of SEQ ID NO: 2, which is at least 60%, 65%, 70%, 75%, 80%, 85%, 90%, 95% homologous to said mature polypeptide.

Fusion proteins comprising a polypeptide according to the invention are also within the scope of the invention. The invention also provides methods of making the polypeptides according to the invention.

The invention also relates to the use of the lipolytic enzyme according to the invention in the baking enzyme composition according to the invention.

### Polynucleotides

The present invention provides an isolated polynucleotide which comprises a nucleotide sequence selected from:
(a) a nucleotide sequence as set out in SEQ ID NO: 1 or a functional equivalent thereof having at least 60, 70, 80 or 90% homology to the nucleotide sequence of SEQ ID NO: 1;
(b) a nucleotide sequence which hybridizes with a polynucleotide being the complement of SEQ ID NO: 1 and wherein said sequence is at least 60, 70, 80 or 90% homologous to the nucleotide sequence of SEQ ID NO: 1;
(c) a nucleotide sequence encoding the mature polypeptide derived from the amino acid sequence according to SEQ ID NO: 2 or a functional equivalent thereof having at least 60, 70, 80 or 90% homology to the mature polypeptide derived from the amino acid sequence of SEQ ID NO: 2;
(d) a sequence which is degenerate as a result of the degeneracy of the genetic code to a sequence as defined in any one of (a), (b), (c);
(e) a nucleotide sequence which is the complement of a nucleotide sequence as defined in (a), (b), (c), or (d).

In one embodiment, the present invention provides polynucleotides encoding lipolytic enzymes, having an amino acid sequence corresponding to the mature polypeptide derived from the amino acid sequence according to SEQ ID NO: 2 or functional equivalents having at least 60, 70, 80 or 90% homology to the amino acid sequence corresponding to the mature polypeptide derived from the amino acid sequence according to SEQ ID NO: 2.

In the context of the present invention “mature polypeptide” is defined herein as a polypeptide having lipolytic activity that is in its final form following translation and any post-translational modifications, such as N-terminal processing, C-terminal truncation, glycosylation, phosphorylation, etc. The process of maturation may depend on the particular expression vector used, the expression host and the production process. Preferrably, the mature polypeptide is amino acids 34 to 304 in the amino acid sequence SEQ ID NO: 2. A “nucleotide sequence encoding the mature polypeptide” is defined herein as the polynucleotide sequence which codes for the mature polypeptide. Preferably the nucleotide sequence encoding the mature polypeptide is nucleotides 100 to 912 in SEQ ID NO: 1.

In another embodiment the invention relates to an isolated polynucleotide encoding an isolated polypeptide having lipolytic activity which is a functional equivalent of the mature polypeptide derived from amino acid sequence of SEQ ID NO:2, which is at least 60%, 65%, 70%, 75%, 80%, 85%, 90%, 95% homologous to said mature polypeptide.

The invention provides polynucleotide sequences comprising the gene encoding the lipolytic enzyme as well as its coding sequence. Accordingly, the invention relates to an isolated polynucleotide comprising the nucleotide sequence according to SEQ ID NO: 1 or to variants such as functional equivalents thereof having at least 60, 70, 80 or 90% homology to SEQ ID NO: 1.

In particular, the invention relates to an isolated polynucleotide comprising a nucleotide sequence which hybridises, preferably under stringent conditions, more preferably under highly stringent conditions, to the complement of a polynucleotide according to SEQ ID NO: 1 and wherein preferably said sequence is at least 60, 70, 80 or 90% homologous to the nucleotide sequence of SEQ ID NO: 1.

More specifically, the invention relates to an isolated polynucleotide comprising or consisting essentially of a nucleotide sequence according to SEQ ID NO: 1.

Such isolated polynucleotide may be obtained by synthesis with methods known to the person skilled in the art.

As used herein, the terms “gene” and “recombinant gene” refer to nucleic acid molecules which may be isolated from chromosomal DNA, which include an open reading frame encoding a protein, e.g. a lipolytic enzyme. A gene may include coding sequences, non-coding sequences, introns and regulatory sequences. Moreover, a gene refers to an isolated nucleic acid molecule or polynucleotide as defined herein.

A nucleic acid molecule of the present invention, such as a nucleic acid molecule having the nucleotide sequence of SEQ ID NO: 1 or a functional equivalent thereof, can be isolated using standard molecular biology techniques and the sequence information provided herein. For example, using all or portion of the nucleic acid sequence of SEQ ID NO: 1 as a hybridization probe, nucleic acid molecules according to the invention can be isolated using standard hybridization and cloning techniques (e.g., as described in Sambrook, J., Fritsh, E. F., and Maniatis, T. Molecular Cloning: A Laboratory Manual. 2nd, ed., Cold Spring Harbor Laboratory, Cold Spring Harbor Laboratory Press, Cold Spring Harbor, N.Y., 1989).

Moreover, a nucleic acid molecule encompassing all or a portion of SEQ ID NO: 1 can be isolated by the polymerase chain reaction (PCR) using synthetic oligonucleotide primers designed based upon the sequence information contained in SEQ ID NO: 1.

A nucleic acid of the invention can be amplified using cDNA, mRNA or alternatively, genomic DNA, as a template and appropriate oligonucleotide primers according to standard PCR amplification techniques. The nucleic acid so amplified can be cloned into an appropriate vector and characterized by DNA sequence analysis.

Furthermore, oligonucleotides corresponding to or hybridisable to the complement of the nucleotide sequences according to the invention can be prepared by standard synthetic techniques, e.g., using an automated DNA synthesizer.

In a preferred embodiment, an isolated nucleic acid molecule of the invention comprises the nucleotide sequence according to SEQ ID NO: 1. The sequence of SEQ ID NO: 1 encodes the polypeptide according to SEQ ID NO: 2 and the lipolytic enzyme according to the mature polypeptide in SEQ ID NO: 2. The lipolytic enzyme according to the mature polypeptide in the amino acid sequence according to SEQ ID NO: 2 is indicated as L01. The nucleotide sequence according to SEQ ID NO: 1 is indicated as DNA L01.

In another preferred embodiment, an isolated nucleic acid molecule of the invention comprises a nucleic acid molecule which is a complement of the nucleotide sequence shown in SEQ ID NO: 1 or a functional equivalent of these nucleotide sequences.

A nucleic acid molecule which is complementary to another nucleotide sequence is one which is sufficiently complementary to the other nucleotide sequence such that it can hybridize to the other nucleotide sequence thereby forming a stable duplex.

One aspect of the invention pertains to isolated nucleic acid molecules that encode a polypeptide of the invention or a variant, such as a functional equivalent thereof, for example a biologically active fragment or domain, as well as nucleic acid molecules sufficient for use as hybridisation probes to identify nucleic acid molecules encoding a polypeptide of the invention and fragments of such nucleic acid molecules suitable for use as PCR primers for the amplification or mutation of nucleic acid molecules.

An “isolated polynucleotide” or “isolated nucleic acid” is a DNA or RNA that is not immediately contiguous with both of the coding sequences with which it is immediately contiguous (one on the 5′ end and one on the 3′ end) in the naturally occurring genome of the organism from which it is derived. Thus, in one embodiment, an isolated nucleic acid includes some or all of the 5′ non-coding (e.g., promotor) sequences that are immediately contiguous to the coding sequence. The term therefore includes, for example, a recombinant DNA that is incorporated into a vector, into an autonomously replicating plasmid or virus, or into the genomic DNA of a prokaryote or eukaryote, or which exists as a separate molecule (e.g., a cDNA or a genomic DNA fragment produced by PCR or restriction endonuclease treatment) independent of other sequences. It also includes a recombinant DNA that is part of a hybrid gene encoding an additional polypeptide that is substantially free of cellular material, viral material, or culture medium (when produced by recombinant DNA techniques), or chemical precursors or other chemicals (when chemically synthesized). Moreover, an “isolated nucleic acid fragment” is a nucleic acid fragment that is not naturally occurring as a fragment and would not be found in the natural state.

As used herein, the terms “polynucleotide” or “nucleic acid molecule” are intended to include DNA molecules (e.g., cDNA or genomic DNA) and RNA molecules (e.g., mRNA) and analogs of the DNA or RNA generated using nucleotide analogs. The nucleic acid molecule can be single-stranded or double-stranded, but preferably is double-stranded DNA. The nucleic acid may be synthesized using oligonucleotide analogs or derivatives (e.g., inosine or phosphorothioate nucleotides). Such oligonucleotides can be used, for example, to prepare nucleic acids that have altered base-pairing abilities or increased resistance to nucleases.

Another embodiment of the invention provides an isolated nucleic acid molecule which is antisense to a nucleic acid molecule according to the invention, e.g., the coding strand of a nucleic acid molecule according to the invention.

Also included within the scope of the invention are the complement strands of the polynucleotides according to the invention.

### Nucleic Acid Fragments, Probes and Primers

A nucleic acid molecule according to the invention may comprise only a portion or a fragment of the nucleic acid sequence according to SEQ ID NO: 1, for example a fragment which can be used as a probe or primer or a fragment encoding a portion of a the protein according to the invention. The nucleotide sequence according to the invention allows for the generation of probes and primers designed for use in identifying and/or cloning functional equivalents of the protein according to the invention having at least 60, 70, 80 or 90% homology to the protein according to SEQ ID NO: 2. The probe/primer typically comprises substantially purified oligonucleotide which typically comprises a region of nucleotide sequence that hybridizes preferably under highly stringent conditions to at least about 12 or 15, preferably about 18 or 20, preferably about 22 or 25, more preferably about 30, 35, 40, 45, 50, 55, 60, 65, or 75 or more consecutive nucleotides of a nucleotide sequence according to the invention.

Probes based on the nucleotide sequences according to the invention, more preferably based on SEQ ID NO: 1 can be used to detect transcripts or genomic sequences encoding the same or homologous proteins for instance in organisms. In preferred embodiments, the probe further comprises a label group attached thereto, e.g., the label group can be a radioisotope, a fluorescent compound, an enzyme, or an enzyme cofactor. Such probes can also be used as part of a diagnostic test kit for identifying cells which express a protein according to the invention.

### Identity & Homology

The terms “homology” or “percent identity” are used interchangeably herein. For the purpose of this invention, it is defined here that in order to determine the percent homology of two amino acid sequences or of two nucleic acid sequences, the sequences are aligned for optimal comparison purposes. In order to optimize the alignment between the two sequences gaps may be introduced in any of the two sequences that are compared. Such alignment can be carried out over the full length of the sequences being compared. Alternatively, the alignment may be carried out over a shorter length, for example over about 20, about 50, about 100 or more nucleic acids/based or amino acids. The identity is the percentage of identical matches between the two sequences over the reported aligned region.

A comparison of sequences and determination of percent identity between two sequences can be accomplished using a mathematical algorithm. The skilled person will be aware of the fact that several different computer programs are available to align two sequences and determine the homology between two sequences (Kruskal, J. B. (1983) An overview of squence comparison In D. Sankoff and J. B. Kruskal, (ed.), Time warps, string edits and macromolecules: the theory and practice of sequence comparison, pp. 1-44 Addison Wesley). The percent identity between two amino acid sequences or between two nucleotide sequences may be determined using the Needleman and Wunsch algorithm for the alignment of two sequences. (Needleman, S. B. and Wunsch, C. D. (1970) J. Mol. Biol. 48, 443-453). Both aminoacid sequences and nucleotide sequences can be aligned by the algorithm. The Needleman-Wunsch algorithm has been implemented in the computer program NEEDLE. For the purpose of this invention the NEEDLE program from the EMBOSS package was used (version 2.8.0 or higher, EMBOSS: The European Molecular Biology Open Software Suite (2000) Rice, P. Longden, I. and Bleasby, A. Trends in Genetics 16, (6) pp 276-277, http://emboss.bioinformatics.nl/). For protein sequences EBLOSUM62 is used for the substitution matrix. For nucleotide sequence, EDNAFULL is used. The optional parameters used are a gap-open penalty of 10 and a gap extension penalty of 0.5. The skilled person will appreciate that all these different parameters will yield slightly different results but that the overall percentage identity of two sequences is not significantly altered when using different algorithms.

After alignment by the program NEEDLE as described above the percentage of identity between a query sequence and a sequence of the invention is calculated as follows: Number of corresponding positions in the alignment showing an identical aminoacid or identical nucleotide in both sequences devided by the total length of the alignment after substraction of the total number of gaps in the alignment. The identity defined as herein can be obtained from NEEDLE by using the NOBRIEF option and is labeled in the output of the program as “longest-identity”.

The nucleic acid and protein sequences of the present invention can further be used as a “query sequence” to perform a search against public databases to, for example, identify other family members or related sequences. Such searches can be performed using the NBLAST and XBLAST programs (version 2.0) of Altschul, et al. (1990) J. Mol. Biol. 215:403-10. BLAST nucleotide searches can be performed with the NBLAST program, score=100, wordlength=12 to obtain nucleotide sequences homologous to nucleic acid molecules of the invention. BLAST protein searches can be performed with the XBLAST program, score=50, wordlength=3 to obtain amino acid sequences homologous to protein molecules of the invention. To obtain gapped alignments for comparison purposes, Gapped BLAST can be utilized as described in Altschul et al., (1997) Nucleic Acids Res. 25(17): 3389-3402. When utilizing BLAST and Gapped BLAST programs, the default parameters of the respective programs (e.g., XBLAST and NBLAST) can be used. See the homepage of the National Center for Biotechnology Information at http://www.ncbi.nlm.nih.gov/.

### Hybridisation

As used herein, the term “hybridizing” is intended to describe conditions for hybridization and washing under which nucleotide sequences at least about 60%, 65%, 80%, 85%, 90%, preferably at least 93%, more preferably at least 95% and most preferably at least 98% homologous to each other typically remain hybridized to the complement of each other.

A preferred, non-limiting example of such hybridization conditions are hybridization in 6× sodium chloride/sodium citrate (SSC) at about 45° C., followed by one or more washes in 1×SSC, 0.1% SDS at 50° C., preferably at 55° C., preferably at 60° C. and even more preferably at 65° C.

Highly stringent conditions include, for example, hybridizing at 68° C. in 5×SSC/5×Denhardt's solution/1.0% SDS and washing in 0.2×SSC/0.1% SDS at room temperature. Alternatively, washing may be performed at 42° C.

The skilled artisan will know which conditions to apply for stringent and highly stringent hybridisation conditions. Additional guidance regarding such conditions is readily available in the art, for example, in Sambrook et al., 1989, Molecular Cloning, A Laboratory Manual, Cold Spring Harbor Press, N.Y.; and Ausubel et al. (eds.), 1995, Current Protocols in Molecular Biology, (John Wiley & Sons, N.Y.).

Of course, a polynucleotide which hybridizes only to a poly A sequence (such as the 3′ terminal poly(A) tract of mRNAs), or to a complementary stretch of T (or U) resides, would not be included in a polynucleotide of the invention used to specifically hybridize to a portion of a nucleic acid of the invention, since such a polynucleotide would hybridize to any nucleic acid molecule containing a poly (A) stretch or the complement thereof (e.g., practically any double-standed cDNA clone).

Obtaining Full Length DNA from Other Organisms

In a typical approach, cDNA libraries constructed from other organisms, e.g. filamentous fungi, in particular from the species Fusarium can be screened.

For example, Fusarium strains can be screened for homologous polynucleotides with respect to SEQ ID NO:1, by Northern blot analysis. Upon detection of transcripts homologous to polynucleotides according to the invention, cDNA libraries can be constructed from RNA isolated from the appropriate strain, utilizing standard techniques well known to those of skill in the art. Alternatively, a total genomic DNA library can be screened using a probe hybridisable to a polynucleotide according to the invention.

Homologous gene sequences can be isolated, for example, by performing PCR using two degenerate oligonucleotide primer pools designed on the basis of nucleotide sequences as taught herein.

The template for the reaction can be cDNA obtained by reverse transcription of mRNA prepared from strains known or suspected to express a polynucleotide according to the invention. The PCR product can be subcloned and sequenced to ensure that the amplified sequences represent the sequences of a new nucleic acid sequence according to the invention, or a functional equivalent thereof.

The PCR fragment can then be used to isolate a full-length cDNA clone by a variety of known methods. For example, the amplified fragment can be labeled and used to screen a bacteriophage or cosmid cDNA library. Alternatively, the labeled fragment can be used to screen a genomic library.

PCR technology also can be used to isolate full-length cDNA sequences from other organisms. For example, RNA can be isolated, following standard procedures, from an appropriate cellular or tissue source. A reverse transcription reaction can be performed on the RNA using an oligonucleotide primer specific for the most 5′ end of the amplified fragment for the priming of first strand synthesis.

The resulting RNA/DNA hybrid can then be “tailed” (e.g., with guanines) using a standard terminal transferase reaction, the hybrid can be digested with RNase H, and second strand synthesis can then be primed (e.g., with a poly-C primer). Thus, cDNA sequences upstream of the amplified fragment can easily be isolated. For a review of useful cloning strategies, see e.g., Sambrook et al., supra; and Ausubel et al., supra.

### Vectors

Another aspect of the invention pertains to vectors, including cloning and expression vectors, comprising a polynucleotide sequence according to the invention encoding a polypeptide having lipolytic acitivity or a functional equivalent thereof according to the invention. The invention also pertains to methods of growing, transforming or transfecting such vectors in a suitable host cell, for example under conditions in which expression of a polypeptide of the invention occurs. As used herein, the term “vector” refers to a nucleic acid molecule capable of transporting another nucleic acid to which it has been linked.

Polynucleotides of the invention can be incorporated into a recombinant replicable vector, for example a cloning or expression vector. The vector may be used to replicate the nucleic acid in a compatible host cell. Thus in a further embodiment, the invention provides a method of making polynucleotides of the invention by introducing a polynucleotide of the invention into a replicable vector, introducing the vector into a compatible host cell, and growing the host cell under conditions which bring about replication of the vector. The vector may be recovered from the host cell. Suitable host cells are described below.

The vector into which the expression cassette or polynucleotide of the invention is inserted may be any vector which may conveniently be subjected to recombinant DNA procedures, and the choice of the vector will often depend on the host cell into which it is to be introduced.

A vector according to the invention may be an autonomously replicating vector, i.e. a vector which exists as an extra-chromosomal entity, the replication of which is independent of chromosomal replication, e.g. a plasmid. Alternatively, the vector may be one which, when introduced into a host cell, is integrated into the host cell genome and replicated together with the chromosome (s) into which it has been integrated.

One type of vector is a “plasmid”, which refers to a circular double stranded DNA loop into which additional DNA segments can be ligated. Another type of vector is a viral vector, wherein additional DNA segments can be ligated into the viral genome. Certain vectors are capable of autonomous replication in a host cell into which they are introduced (e.g., bacterial vectors having a bacterial origin of replication and episomal mammalian vectors). Other vectors (e.g., non-episomal mammalian vectors) are integrated into the genome of a host cell upon introduction into the host cell, and thereby are replicated along with the host genome. Moreover, certain vectors are capable of directing the expression of genes to which they are operatively linked. Such vectors are referred to herein as “expression vectors”. In general, expression vectors of utility in recombinant DNA techniques are often in the form of plasmids. The terms “plasmid” and “vector” can be used interchangeably herein as the plasmid is the most commonly used form of vector. However, the invention is intended to include such other forms of expression vectors, such as cosmid, viral vectors (e.g., replication defective retroviruses, adenoviruses and adeno-associated viruses) and phage vectors which serve equivalent functions.

Vectors according to the invention may be used in vitro, for example for the production of RNA or used to transfect or transform a host cell.

A vector of the invention may comprise two or more, for example three, four or five, polynucleotides of the invention, for example for overexpression.

The recombinant expression vectors of the invention comprise a nucleic acid of the invention in a form suitable for expression of the nucleic acid in a host cell, which means that the recombinant expression vector includes one or more regulatory sequences, selected on the basis of the host cells to be used for expression, which is operably linked to the nucleic acid sequence to be expressed.

Within a recombinant expression vector, “operably linked” is intended to mean that the nucleotide sequence of interest is linked to the regulatory sequence(s) in a manner which allows for expression of the nucleotide sequence (e.g., in an in vitro transcription/translation system or in a host cell when the vector is introduced into the host cell), i.e. the term “operably linked” refers to a juxtaposition wherein the components described are in a relationship permitting them to function in their intended manner. A regulatory sequence such as a promoter, enhancer or other expression regulation signal “operably linked” to a coding sequence is positioned in such a way that expression of the coding sequence is achieved under condition compatible with the control sequences or the sequences are arranged so that they function in concert for their intended purpose, for example transcription initiates at a promoter and proceeds through the DNA sequence encoding the polypeptide.

The term “regulatory sequence” is intended to include promoters, enhancers and other expression control elements (e.g., polyadenylation signal). Such regulatory sequences are described, for example, in Goeddel; Gene Expression Technology: Methods in Enzymology 185, Academic Press, San Diego, Calif. (1990).

The term regulatory sequences includes those sequences which direct constitutive expression of a nucleotide sequence in many types of host cells and those which direct expression of the nucleotide sequence only in a certain host cell (e.g. tissue-specific regulatory sequences).

A vector or expression construct for a given host cell may thus comprise the following elements operably linked to each other in a consecutive order from the 5′-end to 3′-end relative to the coding strand of the sequence encoding the polypeptide of the first invention: (1) a promoter sequence capable of directing transcription of the nucleotide sequence encoding the polypeptide in the given host cell; (2) optionally, a signal sequence capable of directing secretion of the polypeptide from the given host cell into a culture medium; (3) a DNA sequence of the invention encoding a mature and preferably active form of a polypeptide having having lipolytic activity according to the invention; and preferably also (4) a transcription termination region (terminator) capable of terminating transcription downstream of the nucleotide sequence encoding the polypeptide.

Downstream of the nucleotide sequence according to the invention there may be a 3′ untranslated region containing one or more transcription termination sites (e.g. a terminator). The origin of the terminator is less critical. The terminator can, for example, be native to the DNA sequence encoding the polypeptide. However, preferably a yeast terminator is used in yeast host cells and a filamentous fungal terminator is used in filamentous fungal host cells. More preferably, the terminator is endogenous to the host cell (in which the nucleotide sequence encoding the polypeptide is to be expressed). In the transcribed region, a ribosome binding site for translation may be present. The coding portion of the mature transcripts expressed by the constructs will include a translation initiating AUG at the beginning and a termination codon appropriately positioned at the end of the polypeptide to be translated.

Enhanced expression of the polynucleotide of the invention may also be achieved by the selection of heterologous regulatory regions, e.g. promoter, secretion leader and/or terminator regions, which may serve to increase expression and, if desired, secretion levels of the protein of interest from the expression hostand/or to provide for the inducible control of the expression of a polypeptide of the invention.

It will be appreciated by those skilled in the art that the design of the expression vector can depend on such factors as the choice of the host cell to be transformed, the level of expression of protein desired, etc. The expression vectors of the invention can be introduced into host cells to thereby produce proteins or peptides, encoded by nucleic acids as described herein (e.g. the polypeptide having lipolytic activity according to the invention, mutant forms the polypeptide, fragments, variants or functional equivalents thereof, fusion proteins, etc.).

The recombinant expression vectors of the invention can be designed for expression of the polypeptides according to the invention in prokaryotic or eukaryotic cells. For example, the polypeptides according to the invention can be produced in bacterial cells such as E. coli and Bacilli, insect cells (using baculovirus expression vectors), fungal cells, yeast cells or mammalian cells. Suitable host cells are discussed further in Goeddel, Gene Expression Technology: Methods in Enzymology 185, Academic Press, San Diego, Calif. (1990). Alternatively, the recombinant expression vector can be transcribed and translated in vitro, for example using T7 promoter regulatory sequences and T7 polymerase.

For most filamentous fungi and yeast, the vector or expression construct is preferably integrated in the genome of the host cell in order to obtain stable transformants. However, for certain yeasts also suitable episomal vectors are available into which the expression construct can be incorporated for stable and high level expression, examples thereof include vectors derived from the 2μ and pKD1 plasmids of Saccharomyces and Kluyveromyces, respectively, or vectors containing an AMA sequence (e.g. AMA1 from Aspergillus). In case the expression constructs are integrated in the host cells genome, the constructs are either integrated at random loci in the genome, or at predetermined target loci using homologous recombination, in which case the target loci preferably comprise a highly expressed gene.

Accordingly, expression vectors useful in the present invention include chromosomal-, episomal- and virus-derived vectors e.g., vectors derived from bacterial plasmids, bacteriophage, yeast episome, yeast chromosomal elements, viruses such as baculoviruses, papova viruses, vaccinia viruses, adenoviruses, fowl pox viruses, pseudorabies viruses and retroviruses, and vectors derived from combinations thereof, such as those derived from plasmid and bacteriophage genetic elements, such as cosmids and phagemids.

The nucleotide insert should be operatively linked to an appropriate promoter. Aside from the promoter native to the gene encoding the polypeptide of the invention, other promoters may be used to direct expression of the polypeptide of the invention. The promoter may be selected for its efficiency in directing the expression of the polypeptide of the invention in the desired expression host. Examples of promoters which may be useful in the invention include the phage lambda PL promoter, the E. coli lac, trp and tac promoters, the SV40 early and late promoters and promoters of retroviral LTRs, to name a few. Other suitable promoters will be known to the skilled person. In a specific embodiment, promoters are preferred that are capable of directing a high expression level of the polypeptides according to the invention in a fungus or yeast. Such promoters are known in the art.

A variety of promoters can be used that are capable of directing transcription in the host cells of the invention. Preferably the promoter sequence is derived from a highly expressed gene. Examples of preferred highly expressed genes from which promoters are preferably derived and/or which are comprised in preferred predetermined target loci for integration of expression constructs, include but are not limited to genes encoding glycolytic enzymes such as triosephosphate isomerases (TPI), glyceraldehyde-phosphate dehydrogenases (GAPDH), phosphoglycerate kinases (PGK), pyruvate kinases (PYK or PKI), alcohol dehydrogenases (ADH), as well as genes encoding amylases, glucoamylases, proteases, xylanases, cellobiohydrolases, β-galactosidases, alcohol (methanol) oxidases, elongation factors and ribosomal proteins. Specific examples of suitable highly expressed genes include e.g. the LAC4 gene from Kluyveromyces sp., the methanol oxidase genes (AOX and MOX) from Hansenula and Pichia, respectively, the glucoamylase (g/aA) genes from A. niger and A. awamori, the A. oryzae TAKA-amylase gene, the A. nidulans gpdA gene and the T. reesei cellobiohydrolase genes.

Examples of strong constitutive and/or inducible promoters which are preferred for use in fungal expression hosts are those which are obtainable from the fungal genes for xylanase (xlnA), phytase, ATP-synthetase, subunit 9 (oliC), triose phosphate isomerase (tpi), alcohol dehydrogenase (AdhA), α-amylase (amy), amyloglucosidase (AG-from the glaA gene), acetamidase (amdS) and glyceraldehyde-3-phosphate dehydrogenase (gpd) promoters.

Examples of strong yeast promoters are those obtainable from the genes for alcohol dehydrogenase, lactase, 3-phosphoglycerate kinase andtriosephosphate isomerase.

Examples of strong bacterial promoters are the α-amylase and SPo2 promoters as well as promoters from extracellular protease genes.

Promoters suitable for plant cells include nopaline synthase (nos), octopine synthase (ocs), mannopine synthase (mas), ribulose small subunit (rubisco ssu), histone, rice actin, phaseolin, cauliflower mosaic virus (CMV) 35S and 19S and circovirus promoters.

All of the above-mentioned promoters are readily available in the art.

The vector may further include sequences flanking the polynucleotide giving rise to RNA which comprise sequences homologous to eukaryotic genomic sequences or viral genomic sequences. This will allow the introduction of the polynucleotides of the invention into the genome of a host cell.

The vector may contain a polynucleotide of the invention oriented in an antisense direction to provide for the production of antisense RNA.

Vector DNA can be introduced into prokaryotic or eukaryotic cells via conventional transformation or transfection techniques. As used herein, the terms “transformation” and “transfection” are intended to refer to a variety of art-recognized techniques for introducing foreign nucleic acid (e.g., DNA) into a host cell, including calcium phosphate or calcium chloride co-percipitation, DEAE-dextran-mediated transfection, transduction, infection, lipofection, cationic lipidmediated transfection or electroporation. Suitable methods for transforming or transfecting host cells can be found in Sambrook, et al. (Molecular Cloning: A Laboratory Manual, 2^{nd}, ed. Cold Spring Harbor Laboratory, Cold Spring Harbor Laboratory Press, Cold Spring Harbor, N.Y., 1989), Davis et al., Basic Methods in Molecular Biology (1986) and other laboratory manuals.

For stable transfection of mammalian cells, it is known that, depending upon the expression vector and transfection technique used, only a small fraction of cells may integrate the foreign DNA into their genome. In order to identify and select these integrants, a gene that encodes a selectable marker (e.g., resistance to antibiotics) is generally introduced into the host cells along with the gene of interest. Preferred selectable markers include, but are not limited to, those which confer resistance to drugs or which complement a defect in the host cell. They include e.g. versatile marker genes that can be used for transformation of most filamentous fungi and yeasts such as acetamidase genes or cDNAs (the amdS, niaD, facA genes or cDNAs from A. nidulans, A. oryzae or A. niger), or genes providing resistance to antibiotics like G418, hygromycin, bleomycin, kanamycin, methotrexate, phleomycin orbenomyl resistance (benA). Alternatively, specific selection markers can be used such as auxotrophic markers which require corresponding mutant host strains: e.g. URA3 (from S. cerevisiae or analogous genes from other yeasts), pyrG or pyrA (from A. nidulans or A. niger), argB (from A. nidulans or A. niger) or trpC. In a preferred embodiment the selection marker is deleted from the transformed host cell after introduction of the expression construct so as to obtain transformed host cells capable of producing the polypeptide which are free of selection marker genes.

Other markers include ATP synthetase, subunit 9 (oliC), orotidine-5′-phosphatedecarboxylase (pvrA), the bacterial G418 resistance gene (this may also be used in yeast, but not in fungi), the ampicillin resistance gene (E. coli), the neomycin resistance gene (Bacillus) and the E. coli uidA gene, coding for β-glucuronidase (GUS). Vectors may be used in vitro, for example for the production of RNA or used to transfect or transform a host cell.

Expression of proteins in prokaryotes is often carried out in E. coli with vectors containing constitutive or inducible promoters directing the expression of either fusion or non-fusion proteins. Fusion vectors add a number of amino acids to a protein encoded therein, e.g. to the amino terminus of the recombinant protein. Such fusion vectors typically serve three purposes: 1) to increase expression of recombinant protein; 2) to increase the solubility of the recombinant protein; and 3) to aid in the purification of the recombinant protein by acting as a ligand in affinity purification. Often, in fusion expression vectors, a proteolytic cleavage site is introduced at the junction of the fusion moiety and the recombinant protein to enable separation of the recombinant protein from the fusion moiety subsequent to purification of the fusion protein.

As indicated, the expression vectors will preferably contain selectable markers. Such markers include dihydrofolate reductase or neomycin resistance for eukaryotic cell culture and tetracyline or ampicillin resistance for culturing in E. coli and other bacteria. Representative examples of appropriate host include bacterial cells, such as E. coli, Streptomyces Salmonella typhimurium and certain Bacillus species; fungal cells such as Aspergillus species, for example A. niger, A. oryzae and A. nidulans, such as yeast such as Kluyveromyces, for example K. lactis and/or Puchia, for example P. pastoris; insect cells such as Drosophila S2 and Spodoptera Sf9; animal cells such as CHO, COS and Bowes melanoma; and plant cells. Appropriate culture mediums and conditions for the above-described host cells are known in the art.

Vectors preferred for use in bacteria are for example disclosed in WO-A1-2004/074468, which are hereby enclosed by reference. Other suitable vectors will be readily apparent to the skilled artisan.

Known bacterial promotors suitable for use in the present invention include the promoters disclosed in WO-A1-2004/074468, which are hereby enclosed by reference.

Transcription of the DNA encoding the polypeptides of the present invention by higher eukaryotes may be increased by inserting an enhancer sequence into the vector. Enhancers are cis-acting elements of DNA, usually about from 10 to 300 bp that act to increase transcriptional activity of a promoter in a given host cell-type. Examples of enhancers include the SV40 enhancer, which is located on the late side of the replication origin at by 100 to 270, the cytomegalovirus early promoter enhancer, the polyoma enhancer on the late side of the replication origin, and adenovirus enhancers.

For secretion of the translated protein into the lumen of the endoplasmic reticulum, into the periplasmic space or into the extracellular environment, appropriate secretation signal may be incorporated into the expressed gene. The signals may be endogenous to the polypeptide or they may be heterologous signals.

The polypeptide according to the invention may be produced in a modified form, such as a fusion protein, and may include not only secretion signals but also additional heterologous functional regions. Thus, for instance, a region of additional amino acids, particularly charged amino acids, may be added to the N-terminus of the polypeptide to improve stability and persistence in the host cell, during purification or during subsequent handling and storage. Also, peptide moieties may be added to the polypeptide to facilitate purification.

### Polypeptides According to the Invention

The invention provides an isolated polypeptide having lipolytic activity comprising:
(a) the mature polypeptide derived from the amino acid sequence according to SEQ ID NO: 2 or a functional equivalent thereof having an amino acid sequence at least 60, 70, 80 or 90% homologous to the mature polypeptide derived from the amino acid sequence according to SEQ ID NO: 2;
(b) an amino acid sequence encoded by a polynucleotide according to the invention.

Therefore the invention provides an isolated polypeptide having lipolytic activity comprising the mature polypeptide derived from the amino acid sequence according to SEQ ID NO: 2, preferably comprising amino acids 34-304 of SEQ ID NO: 2, and an amino acid sequence obtainable by expressing the polynucleotide of SEQ ID NO: 1 in an appropriate host. Also, a peptide or polypeptide being a functional equivalent and being at least 60, 70, 80 or 90% homologous to the mature polypeptide in the amino acid sequence according to SEQ ID NO: 2 is comprised within the present invention.

In another embodiment the invention also relates to an isolated polypeptide having lipolytic activity which is a functional equivalent of the mature polypeptide derived from the amino acid sequence of SEQ ID NO: 2, which is at least 60%, 65%, 70%, 75%, 80%, 85%, 90%, 95% homologous to said mature polypeptide.

The above polypeptides are collectively comprised in the term “polypeptides according to the invention”.

The terms “peptide” and “oligopeptide” are considered synonymous (as is commonly recognized) and each term can be used interchangeably as the context requires to indicate a chain of at least two amino acids coupled by peptidyl linkages. The word “polypeptide” (or protein) is used herein for chains containing more than seven amino acid residues. All oligopeptide and polypeptide formulas or sequences herein are written from left to right and in the direction from amino terminus to carboxy terminus. The one-letter code of amino acids used herein is commonly known in the art and can be found in Sambrook, et al. (Molecular Cloning: A Laboratory Manual, 2^{nd}, ed. Cold Spring Harbor Laboratory, Cold Spring Harbor Laboratory Press, Cold Spring Harbor, N.Y., 1989),

By “isolated” polypeptide or protein is intended a polypeptide or protein removed from its native environment. For example, recombinantly produced polypeptides and proteins produced in host cells are considered isolated for the purpose of the invention as are native or recombinant polypeptides which have been substantially purified by any suitable technique such as, for example, the single-step purification method disclosed in Smith and Johnson, Gene 67:31-40 (1988).

As is known to the person skilled in the art it is possible that the N-termini of SEQ ID NO: 2 or of the mature polypeptide in the amino acid sequence according to SEQ ID NO: 2 might be heterogeneous as well as the C-terminus of SEQ ID NO: 2 or of the mature polypeptide in the amino acid sequence according to SEQ ID NO: 2, due to processing errors during maturation. In particular such processing errors might occur upon overexpression of the polypeptide. In addition, exo-protease activity might give rise to heterogeneity. The extent to which heterogeneity occurs depends also on the host and fermentation protocols that are used. Such C-terminual processing artefacts might lead to shorter polypeptides or longer polypeptides as indicated with SEQ ID NO: 2 or with the mature polypeptide in the amino acid sequence according to SEQ ID NO: 2. As a result of such errors the N-terminus might also be heterogeneous.

In a further embodiment, the invention provides an isolated polynucleotide encoding at least one functional domain of a polypeptide according to SEQ ID NO: 2 or of the mature polypeptide in the amino acid sequence according to SEQ ID NO: 2 which contain additional residues and start at position −1, or −2, or −3 etc. Alternatively, it might lack certain residues and as a consequence start at position 2, or 3, or 4 etc. Also additional residues may be present at the C-terminus, e.g. at position 347, 348 etc. Alternatively, the C-terminus might lack certain residues and as a consequence end at position 345 or 344.

The lipolytic enzyme according to the invention can be recovered and purified from recombinant cell cultures by methods known in the art (Protein Purification Protocols, Methods in Molecular Biology series by Paul Cutler, Humana Press, 2004).

Polypeptides of the present invention include naturally purified products, products of chemical synthetic procedures, and products produced by recombinant techniques from a prokaryotic or eukaryotic host, including, for example, bacterial, yeast, higher plant, insect and mammalian cells. Depending upon the host employed in a recombinant production procedure, the polypeptides of the present invention may be glycosylated or may be non-glycosylated. In addition, polypeptides of the invention may also include an initial modified methionine residue, in some cases as a result of host-mediated processes.

### Polypeptide Fragments

The invention also features biologically active fragments of the polypeptides according to the invention.

Biologically active fragments of a polypeptide of the invention include polypeptides comprising amino acid sequences sufficiently identical to or derived from the amino acid sequence of the protein according to the invention (e.g., the mature polypeptide derived from the amino acid sequence of SEQ ID NO: 2), which include fewer amino acids than the full length protein but which exhibit at least one biological activity of the corresponding full-length protein, preferably which exhibit lipolytic activity. Typically, biologically active fragments comprise a domain or motif with at least one activity of the protein according to the invention. A biologically active fragment of a protein of the invention can be a polypeptide which is, for example, 5, 10, 15, 20, 25, or more amino acids in length shorter than the mature polypeptide in SEQ ID NO: 2, and which has at least 60, 70, 80 or 90% homology to the mature polypeptide in SEQ ID NO: 2. Moreover, other biologically active portions, in which other regions of the protein are deleted, can be prepared by recombinant techniques and evaluated for one or more of the biological activities of the native form of a polypeptide of the invention.

The invention also features nucleic acid fragments which encode the above biologically active fragments of the protein according to the invention.

### Fusion Proteins

The polypeptides according to the invention or functional equivalents thereof, e.g., biologically active portions thereof, can be operably linked to a polypeptide not according to the invention (e.g., heterologous amino acid sequences) to form fusion proteins. A “polypeptide not according to the invention” refers to a polypeptide having an amino acid sequence corresponding to a protein which is not substantially homologous to the protein according to the invention. Such “polypeptide not according to the invention” can be derived from the same or a different organism. Within a fusion protein the polypeptide according to the invention can correspond to all or a biologically active fragment of the lipolytic enzyme according to the invention. In a preferred embodiment, a fusion protein comprises at least two biologically active portions of the protein according to the invention. Within the fusion protein, the term “operably linked” is intended to indicate that the polypeptide according to the invention and the polypeptide not according to the invention are fused in-frame to each other. The polypeptide not according to the invention can be fused to the N-terminus or C-terminus of the polypeptide.

For example, in one embodiment, the fusion protein is a fusion protein in which the amino acid sequences are fused to the C-terminus of the GST sequences. Such fusion proteins can facilitate the purification of the recombinant protein according to the invention. In another embodiment, the fusion protein according to the invention is a protein containing a heterologous signal sequence at its N-terminus. In certain host cells (e.g., mammalian and yeast host cells), expression and/or secretion of the protein according to the invention can be increased through use of a hetereologous signal sequence.

In another example, the gp67 secretory sequence of the baculovirus envelope protein can be used as a heterologous signal sequence (Current Protocols in Molecular Biology, Ausubel et al., eds., John Wiley & Sons, 1992). Other examples of eukaryotic heterologous signal sequences include the secretory sequences of melittin and human placental alkaline phosphatase (Stratagene; La Jolla, Calif.). In yet another example, useful prokarytic heterologous signal sequences include the phoA secretory signal (Sambrook et al., supra) and the protein A secretory signal (Pharmacia Biotech; Piscataway, N.J.).

A signal sequence can be used to facilitate secretion and isolation of a protein or polypeptide of the invention. Signal sequences are typically characterized by a core of hydrophobic amino acids, which are generally cleaved from the mature protein during secretion in one or more cleavage events. Such signal peptides contain processing sites that allow cleavage of the signal sequence from the mature proteins as they pass through the secretory pathway. The signal sequence directs secretion of the protein, such as from a eukaryotic host into which the expression vector is transformed, and the signal sequence is subsequently or concurrently cleaved. The protein can then be readily purified from the extracellular medium by known methods. Alternatively, the signal sequence can be linked to the protein of interest using a sequence, which facilitates purification, such as with a GST domain. Thus, for instance, the sequence encoding the polypeptide may be fused to a marker sequence, such as a sequence encoding a peptide, which facilitates purification of the fused polypeptide. In certain preferred embodiments of this aspect of the invention, the marker sequence is a hexa-histidine peptide, such as the tag provided in a pQE vector (Qiagen, Inc.), among others, many of which are commercially available. As described in Gentz et al, Proc. Natl. Acad. Sci. USA 86:821-824 (1989), for instance, hexa-histidine provides for convenient purificaton of the fusion protein. The HA tag is another peptide useful for purification which corresponds to an epitope derived of influenza hemaglutinin protein, which has been described by Wilson et al., Cell 37:767 (1984), for instance.

Preferably, a fusion protein according to the invention is produced by standard recombinant DNA techniques. For example, DNA fragments coding for the different polypeptide sequences are ligated together in-frame in accordance with conventional techniques, for example by employing blunt-ended or stagger-ended termini for ligation, restriction enzyme digestion to provide for appropriate termini, filling-in of cohesive ends as appropriate, alkaline phosphatase treatment to avoid undesirable joining, and enzymatic ligation. In another embodiment, the fusion gene can be synthesized by conventional techniques including automated DNA synthesizers. Alternatively, PCR amplification of gene fragments can be carried out using anchor primers, which give rise to complementary overhangs between two consecutive gene fragments which can subsequently be annealed and reamplified to generate a chimeric gene sequence (see, for example, Current Protocols in Molecular Biology, eds. Ausubel et al. John Wiley & Sons: 1992). Moreover, many expression vectors are commercially available that already encode a fusion moiety (e.g, a GST polypeptide). A nucleic acid encoding for a polypeptide according to the invention can be cloned into such an expression vector such that the fusion moiety is linked in-frame to the protein according to the invention.

### Functional Equivalents

The terms “functional equivalents” and “functional variants” are used interchangeably herein.

Functional equivalents of the polynucleotide according to the invention are isolated polynucleotides having at least 60%, 65%, 70%, 75%, 80%, 85%, preferably at least 90% homology to the nucleotide sequence of SEQ ID NO: 1 and that encodes a polypeptide that exhibits at least a particular function of the lipolytic enzyme according to the invention, preferably a polypeptide having lipolytic activity. Preferably the lipolytic enzyme according to the invention or polypeptide having lipolytic activity has lipolytic activity on triglycerides, phospholipids and galactolipids in bakery applications, e.g. under dough conditions. A functional equivalent of a polypeptide according to the invention is a polypeptide having at least 60%, 65%, 70%, 75%, 80%, 85%, preferably at least 90% homology to the mature polypeptide derived from the amino acid sequence of SEQ ID NO: 2 and that exhibits at least one function of a lipolytic enzyme according to the invention, preferably which exhibits lipolytic activity, more preferably which exhibits lipolytic activity on triglycerides, phospholipids and galactolipids in bakery applications, e.g. under dough conditions. Functional equivalents as mentioned herewith also encompass biologically active fragments having lipolytic activity as described above.

Functional equivalents of the polypeptide according to the invention may contain substitutions of one or more amino acids of the mature polypeptide derived from the amino acid sequence according to SEQ ID NO: 2 or substitutions, insertions or deletions of amino acids which do not affect the particular functionality of the enzyme. Accordingly, a functionally neutral amino acid substitution is a substitution in the mature polypeptide of the amino acid sequence according to SEQ ID NO: 2 that does not substantially alters its particular functionality. For example, amino acid residues that are conserved among the proteins of the present invention are predicted to be particularly unamenable to alteration. Furthermore, amino acids conserved among the proteins according to the present invention and other lipolytic enzymes are not likely to be amenable to alteration.

Functional equivalents of the polynucleotides according to the invention may typically contain silent mutations or mutations that do not alter the biological function of the encoded polypeptide. Accordingly, the invention provides nucleic acid molecules encoding polypeptides according to the invention that contain changes in amino acid residues that are not essential for a particular biological activity. Such proteins differ in amino acid sequence from the mature polypeptide derived from the amino acid sequence according to SEQ ID NO: 2 and yet retain at least one biological activity thereof, preferably they retain the lipolytic activity. In one embodiment a functional equivalent of the polynucleotide according to the invention comprises a nucleotide sequence encoding a polypeptide according to the invention, wherein the polypeptide comprises a substantially homologous amino acid sequence of at least about 60%, 65%, 70%, 75%, 80%, 85%, preferably at least 90%, 91%, 92%, 93%, 94%, 95%, 96%, 97%, 98%, 99% or more homologous to the mature polypeptide in the amino acid sequence according to SEQ ID NO: 2. In one embodiment the functional equivalent of the mature polypeptide in the amino acid sequence according to SEQ ID NO: 2 having at least 90% homology thereto is the polypeptide having an amino acid sequence according to the mature polypeptide derived from the amino acid sequence according to SEQ ID NO: 4 (indicated hereafter as L02), in another embodiment it is the polypeptide having an amino acid sequence according to the mature polypeptide derived from the amino acid sequence according to SEQ ID NO: 6 (indicated hereafter as L03), and in yet another embdodiment it is the polypeptide having an amino acid sequence according to the mature polypeptide derived from the amino acid sequence according to SEQ ID NO: 8 (indicated hereafter as L04). In a preferred embodiment the mature polypeptide derived from the amino acid sequence according to SEQ ID NO: 4, SEQ ID NO: 6 or SEQ ID NO: 8 respectively is amino acid sequence 34 to 304 in the amino acid sequence according to SEQ ID NO: 4, SEQ ID NO: 6 or SEQ ID NO: 8, respectively.

A functional equivalent of the polynucleotide according to the invention encoding a polypeptide according to the invention will comprise a polynucleotide sequence which is at least about 60%, 65%, 70%, 75%, 80%, 85%, preferably at least 90%, 91%, 92%, 93%, 94%, 95%, 96%, 97%, 98%, 99%, or more homologous to a nucleic acid sequence according to SEQ ID NO 1.

In one embodiment a functional equivalent of the polynucleotide according to SEQ ID NO: 1 having at least 90% homology thereto is the polynucleotide having a nucleotide sequence according to SEQ ID NO: 3 (indicated as DNA L02), in another embodiment it is the polynucleotide having a nucleotide sequence according to SEQ ID NO: 5 (indicated as DNA L03), in yet another embodiment it is the polynucleotide having a nucleotide sequence according to SEQ ID NO: 7 (indicated as DNA L04). The polynucleotide sequence according to SEQ ID NO: 3 encodes the polypeptide according to SEQ ID NO: 4, the polynucleotide sequence according to SEQ ID NO: 5 encodes the polypeptide according to SEQ ID NO: 6, the polynucleotide sequence according toSEQ ID NO: 7 encodes the polypeptide according to SEQ ID NO: 8. In a preferred embodiment polynucleotide 100-912 in SEQ ID NO: 3, 5, 7 respectively encodes for the mature polypeptide in SEQ ID NO: 4, 6, 8.

An isolated polynucleotide encoding a protein homologous to the mature polypeptide derived from the amino acid sequence according to SEQ ID NO: 2 can be created by introducing one or more nucleotide substitutions, additions or deletions into the coding nucleotide sequences according to SEQ ID NO: 1 such that one or more amino acid substitutions, deletions or insertions are introduced into the encoded protein. Such mutations may be introduced by standard techniques, such as site-directed mutagenesis and PCR-mediated mutagenesis.

Nucleic acids encoding other family members having lipolytic activity, which thus have a nucleotide sequence that differs from SEQ ID NO: 1, 3, 5, 7 and which fullfills to the conditions mentioned above are within the scope of the invention. Moreover, nucleic acids encoding proteins having lipolytic activity, which have an amino acid sequence which differs from the mature polypeptide in the amino acid sequence SEQ ID NO: 2, 4, 6, 8 and which fulfill the conditions mention above are within the scope of the invention.

The polynucleotides according to the invention may be optimized in their codon use, preferably according to the methods described in WO2006/077258 and/or WO2008/000632. WO2008/000632 addresses codon-pair optimization. Codon-pair optimisation is a method wherein the nucleotide sequences encoding a polypeptide are modified with respect to their codon-usage, in particular the codon-pairs that are used, to obtain improved expression of the nucleotide sequence encoding the polypeptide and/or improved production of the encoded polypeptide. Codon pairs are defined as a set of two subsequent triplets (codons) in a coding sequence.

Nucleic acid molecules corresponding to variants (e.g. natural allelic variants) and homologues of the polynucleotides according to the invention can be isolated based on their homology to the nucleic acids disclosed herein using the cDNAs disclosed herein or a suitable fragment thereof, as a hybridisation probe according to standard hybridisation techniques preferably under highly stringent hybridisation conditions.

In another aspect of the invention, improved proteins are provided. Improved proteins are proteins wherein at least one biological activity is improved if compared with the biological activity of the polypeptide having amino acid sequence according to SEQ ID NO: 2. Such proteins may be obtained by randomly introducing mutations along all or part of the coding sequence SEQ ID NO: 1, such as by saturation mutagenesis, and the resulting mutants can be expressed recombinantly and screened for biological activity. For instance, the art provides for standard assays for measuring the enzymatic activity of lipolytic enzymes and thus improved proteins may easily be selected.

In a preferred embodiment the polypeptide according to the invention has an amino acid sequence according to amino acids 34 to 304 in SEQ ID NO: 2. In another embodiment, the polypeptide is at least 90% homologous to the mature polypeptide derived from the amino acid sequence according to SEQ ID NO: 2 and retains at least one biological activity of a mature polypeptide derived from the amino acid sequence according to SEQ ID NO: 2, preferably it retains the lipolytic activity, more preferably retains lipolytic activity on triglycerides, phospholipids and galactolipids in bakery applications, e.g. under dough conditions and yet differs in amino acid sequence due to natural variation or mutagenesis as described above.

In a further preferred embodiment, the protein according to the invention has an amino acid sequence encoded by an isolated nucleic acid fragment which hybridizes with a polynucleotide being the complement of SEQ ID NO: 1 and wherein said nucleotide sequence is at least 90% homologous to the nucleotide sequence of SEQ ID NO: 1, preferably under highly stringent hybridisation conditions.

Accordingly, the protein according to the invention is preferably a protein which comprises an amino acid sequence at least about 90%, 91% 92% 93% 94%, 95%, 96%, 97%, 98%, 99% or more homologous to the mature polypeptide derived from the amino acid sequence according to SEQ ID NO 2 and retains at least one functional activity of the mature polypeptide in the amino acid sequence according to SEQ ID NO: 2, preferably it retains the lipolytic activity, more preferably retains lipolytic activity on triglycerides, phospholipids and galactolipids in bakery applications, e.g. under dough conditions.

Functional equivalents of a protein according to the invention can also be identified e.g. by screening combinatorial libraries of mutants, e.g. truncation mutants, of the protein of the invention for lipolytic enzyme activity. In one embodiment, a variegated library of variants is generated by combinatorial mutagenesis at the nucleic acid level. A variegated library of variants can be produced by, for example, enzymatically ligating a mixture of synthetic oligonucleotides into gene sequences such that a degenerate set of potential protein sequences is expressible as individual polypeptides, or alternatively, as a set of larger fusion proteins (e.g. for phage display). There are a variety of methods that can be used to produce libraries of potential variants of the polypeptides of the invention from a degenerate oligonucleotide sequence. Methods for synthesizing degenerate oligonucleotides are known in the art (see, e.g., Narang (1983) Tetrahedron 39:3; Itakura et al. (1984) Annu. Rev. Biochem. 53:323; Itakura et al. (1984) Science 198:1056; Ike et al. (1983) Nucleic Acid Res. 11:477).

In addition, libraries of fragments of the coding sequence of a polypeptide of the invention can be used to generate a variegated population of polypeptides for screening a subsequent selection of variants. For example, a library of coding sequence fragments can be generated by treating a double stranded PCR fragment of the coding sequence of interest with a nuclease under conditions wherein nicking occurs only about once per molecule, denaturing the double stranded DNA, renaturing the DNA to form double stranded DNA which can include sense/antisense pairs from different nicked products, removing single stranded portions from reformed duplexes by treatment with S1 nuclease, and ligating the resulting fragment library into an expression vector. By this method, an expression library can be derived which encodes N-terminal and internal fragments of various sizes of the protein of interest.

Several techniques are known in the art for screening gene products of combinatorial libraries made by point mutations of truncation, and for screening cDNA libraries for gene products having a selected property. The most widely used techniques, which are amenable to high through-put analysis, for screening large gene libraries typically include cloning the gene library into replicable expression vectors, transforming appropriate cells with the resulting library of vectors, and expressing the combinatorial genes under conditions in which detection of a desired activity facilitates isolation of the vector encoding the gene whose product was detected. Recursive ensemble mutagenesis (REM), a technique which enhances the frequency of functional mutants in the libraries, can be used in combination with the screening assays to identify variants of a protein of the invention (Arkin and Yourvan (1992) Proc. Natl. Acad. Sci. USA 89:7811-7815; Delgrave et al. (1993) Protein Engineering 6(3): 327-331).

Fragments of a polynucleotide according to the invention may also comprise polynucleotides not encoding functional polypeptides. Such polynucleotides may function as probes or primers for a PCR reaction.

Nucleic acids according to the invention irrespective of whether they encode functional or non-functional polypeptides can be used as hybridization probes or polymerase chain reaction (PCR) primers. Uses of the nucleic acid molecules of the present invention that do not encode a polypeptide having a lipolytic activity according to the invention include, inter alia, (1) isolating the gene encoding the protein, or allelic variants thereof from a cDNA library; (2) in situ hybridization (e.g. FISH) to metaphase chromosomal spreads to provide precise chromosomal location of the gene as described in Verma et al., Human Chromosomes: a Manual of Basic Techniques, Pergamon Press, New York (1988); (3) Northern blot analysis for detecting expression of mRNA in specific tissues and/or cells and 4) probes and primers that can be used as a diagnostic tool to analyse the presence of a nucleic acid hybridisable to the probe in a given biological (e.g. tissue) sample.

Also encompassed by the invention is a method of obtaining a functional equivalent of a gene according to the invention. Such a method entails obtaining a labelled probe that includes an isolated nucleic acid which encodes all or a portion of the protein sequence according to the mature polypeptide in the amino acid sequence according to SEQ ID NO: 2 or a variant of any of them; screening a nucleic acid fragment library with the labelled probe under conditions that allow hybridisation of the probe to nucleic acid fragments in the library, thereby forming nucleic acid duplexes, and preparing a full-length gene sequence from the nucleic acid fragments in any labelled duplex to obtain a gene related to the gene according to the invention.

### Host Cells

In another embodiment, the invention features cells, e.g., transformed host cells or recombinant host cells comprising a polynucleotide according to the invention or comprising a vector according to the invention.

A “transformed cell” or “recombinant cell” is a cell into which (or into an ancestor of which) has been introduced, by means of recombinant DNA techniques, a nucleic acid according to the invention. Both prokaryotic and eukaryotic cells are included, e.g., bacteria, fungi, yeast, and the like. Host cells also include, but are not limited to, mammalian cell lines such as CHO, VERO, BHK, HeLa, COS, MDCK, 293, 3T3, WI38, and choroid plexus cell lines. A number of vectors suitable for stable transfection of mammalian cells are available to the public, methods for constructing such cell lines are also publicly known, e.g., in Ausubel et al. (supra). Especially preferred are cells from filamentous fungi, in particular Aspergillus species such as Aspergillus niger or oryzae or awamori.

A host cell can be chosen that modulates the expression of the inserted sequences, or modifies and processes the gene product in a specific, desired fashion. Such modifications (e.g., glycosylation) and processing (e.g., cleavage) of protein products may facilitate optimal functioning of the protein.

Various host cells have characteristic and specific mechanisms for post-translational processing and modification of proteins and gene products. Appropriate cell lines or host systems familiar to those of skill in the art of molecular biology and/or microbiology can be chosen to ensure the desired and correct modification and processing of the foreign protein produced. To this end, eukaryotic host cells that possess the cellular machinery for proper processing of the primary transcript, glycosylation, and phosphorylation of the gene product can be used. Such host cells are well known in the art.

If desired, a cell as described above may be used to in the preparation of a polypeptide according to the invention. Such a method typically comprises cultivating a recombinant host cell (e.g. transformed or transfected with an expression vector as described above) under conditions to provide for expression (by the vector) of a coding sequence encoding the polypeptide, and optionally recovering, more preferably recovering and purifying the produced polypeptide from the cell or culture medium. Polynucleotides of the invention can be incorporated into a recombinant replicable vector, e.g. an expression vector. The vector may be used to replicate the nucleic acid in a compatible host cell. Thus in a further embodiment, the invention provides a method of making a polynucleotide of the invention by introducing a polynucleotide of the invention into a replicable vector, introducing the vector into a compatible host cell, and growing the host cell under conditions which bring about the replication of the vector. The vector may be recovered from the host cell.

Preferably the polypeptide is produced as a secreted protein in which case the nucleotide sequence encoding a mature form of the polypeptide in the expression construct is operably linked to a nucleotide sequence encoding a signal sequence. Preferably the signal sequence is native (homologous) to the nucleotide sequence encoding the polypeptide. Alternatively the signal sequence is foreign (heterologous) to the nucleotide sequence encoding the polypeptide, in which case the signal sequence is preferably endogenous to the host cell in which the nucleotide sequence according to the invention is expressed. Examples of suitable signal sequences for yeast host cells are the signal sequences derived from yeast a-factor genes. Similarly, a suitable signal sequence for filamentous fungal host cells is e.g. a signal sequence derived from a filamentous fungal amyloglucosidase (AG) gene, e.g. the A. niger glaA gene. This may be used in combination with the amyloglucosidase (also called (gluco) amylase) promoter itself, as well as in combination with other promoters. Hybrid signal sequences may also be used with the context of the present invention.

Preferred heterologous secretion leader sequences are those originating from the fungal amyloglucosidase (AG) gene (glaA-both 18 and 24 amino acid versions e.g. from Aspergillus), the α-factor gene (yeasts e.g. Saccharomyces and Kluyveromyces) or the α-amylase gene (Bacillus).

The vectors may be transformed or transfected into a suitable host cell as described above to provide for expression of a polypeptide of the invention. This process may comprise culturing a host cell transformed with an expression vector as described above under conditions to provide for expression by the vector of a coding sequence encoding the polypeptide.

The invention thus provides host cells transformed or transfected with or comprising a polynucleotide or vector of the invention. Preferably the polynucleotide is carried in a vector for the replication and expression of the polynucleotide. The cells will be chosen to be compatible with the said vector and may for example be prokaryotic (for example bacterial), fungal, yeast or plant cells.

A heterologous host may also be chosen wherein the polypeptide of the invention is produced in a form which is substantially free of enzymatic activities that might interfere with the applications, e.g. free from starch degrading, cellulose-degrading or hemicellulose degrading enzymes. This may be achieved by choosing a host which does not normally produce such enzymes.

The invention encompasses processes for the production of the polypeptide of the invention by means of recombinant expression of a DNA sequence encoding the polypeptide. For this purpose the DNA sequence of the invention can be used for gene amplification and/or exchange of expression signals, such as promoters, secretion signal sequences, in order to allow economic production of the polypeptide in a suitable homologous or heterologous host cell. A homologous host cell is a host cell which is of the same species or which is a variant within the same species as the species from which the DNA sequence is derived.

Suitable host cells are preferably prokaryotic microorganisms such as bacteria, or more preferably eukaryotic organisms, for example fungi, such as yeasts or filamentous fungi, or plant cells. In general, yeast cells are preferred over fungal cells because they are easier to manipulate. However, some proteins are either poorly secreted from yeasts, or in some cases are not processed properly (e.g. hyperglycosylation in yeast). In these instances, a fungal host organism should be selected.

The host cell may over-express the polypeptide, and techniques for engineering over-expression are well known. The host may thus have two or more copies of the encoding polynucleotide (and the vector may thus have two or more copies accordingly).

Therefore, in one embodiment of the invention the recombinant host cell according to the invention is capable of expressing or overexpressing a polynucleotide or vector according to the invention.

According to the present invention, the production of the polypeptide of the invention can be effected by the culturing of a host cell according to the invention, which have been transformed with one or more polynucleotides of the present invention, in a conventional nutrient fermentation medium.

The recombinant host cells according to the invention may be cultured using procedures known in the art. For each combination of a promoter and a host cell, culture conditions are available which are conducive to the expression the DNA sequence encoding the polypeptide. After reaching the desired cell density or titre of the polypeptide the culture is stopped and the polypeptide is recovered using known procedures.

The fermentation medium can comprise a known culture medium containing a carbon source (e.g. glucose, maltose, molasses, etc.), a nitrogen source (e.g. ammonium sulphate, ammonium nitrate, ammonium chloride, etc.), an organic nitrogen source (e.g. yeast extract, malt extract, peptone, etc.) and inorganic nutrient sources (e.g. phosphate, magnesium, potassium, zinc, iron, etc.).

The selection of the appropriate medium may be based on the choice of expression host and/or based on the regulatory requirements of the expression construct. Such media are known to those skilled in the art. The medium may, if desired, contain additional components favouring the transformed expression hosts over other potentially contaminating microorganisms.

The fermentation can be performed over a period of 0.5-30 days. It may be a batch, continuous or fed-batch process, suitably at a temperature in the range of, for example, from about 0 to 45° C. and/or at a pH, for example, from about 2 to about 10. Preferred fermentation conditions are a temperature in the range of from about 20 to about 37° C. and/or at a pH of from about 3 to about 9. The appropriate conditions are usually selected based on the choice of the expression host and the protein to be produced.

After fermentation, if necessary, the cells can be removed from the fermentation broth by means of centrifugation or filtration. After fermentation has stopped or after removal of the cells, the polypeptide of the invention may then be recovered and, if desired, purified and isolated by conventional means.

The invention will now be further elucidated by way of examples which however should not been interpreted as limiting the invention.

### EXAMPLES

### Materials and methods

### Assays

### Lipolytic Activity (DLU)

### Unit Definition

One DLU is defined as the amount of enzyme that liberates 1 micromol p-nitrophenol per minute under the conditions of the test (pH 8.5, 37° C.).

### Assay

The lipolytic activity was determined in an assay with the chromogenic substrate p-nitrophenyl palmitate (pNPP). The substrate (Sigma N2752) was dissolved in 2-propanol (3 mg/mL). While vigorously stirring 3.5 mL of this solution was drop wise added to 46.5 mL 100 millimol/l TRIS buffer pH 8.5 containing 1% Triton X-100. At time t=0, 50 μL of sample was mixed with 1 mL substrate solution. While incubating at 37° C. the change in absorption was measured at 405 nm against a sample blank. The slope (deltaOD/time) of the linear part of the curve is used as measure for the activity. The activity is expressed in DLU (DSM Lipase Units).

### Lipase Activity (PLI)

### Unit Definition

One PLI lipase unit is the amount of enzyme that releases 1 μmol free fatty acid from a neutralised olive oil emulsion per minute at 37° C. and pH 7.5.

### Assay

During the enzyme incubation, the free fatty acids generated are titrated with sodium hydroxide to a constant pH of 7.5. The quantity of sodium hydroxide used, is directly proportional to the quantity of free fatty acids formed and thus lipase activity. To obtain reliable data, low acidity olive oil (Sigma cat nr 01514) should be used and the olive oil emulsion should meet specific droplet size requirements. The emulsion is obtained by mixing 50 ml of olive oil with 50 ml of a polyvinyl alcohol solution (Rhodoviol 25/140 from Rhone-Poulenc/Prolabo cat nr 20954 295) and 25 ml water with an Ultra Turrax. No oil droplets should be present that exceed a diameter of 10 microns, 10 to 20% of the droplets should have a diameter between 4 to 9 microns and 80% of the droplets should have a diameter less than 4 microns. The final incubation mixture contains 7.5 ml olive oil emulsion, 5.0 ml CaCl2 solution ((3.675 g Cacl2. 2H2O/250 ml), 1.0 ml albumine solution (200 g/l) and 11.5 ml water. The measurement is conveniently carried out in a pH-stat unit (Radiometer, Copenhagen, Denmark).

### Cellulase Activity (CXU)

### Unit Definition

One CXU is the amount of enzyme that hydrolyses an amount of carboxymethyl cellulose (CMC) per hour under the conditions of the test giving an amount of reducing sugars equivalent to 0.5 mg glucose.

### Assay

The quantity of reducing sugars formed is quantitatively determined with di-nitro-saliscylic acid. The CMC substrate is prepared by suspending 18 g of CMC (Blanose R. 110, Novacel Paris, France) in 900 ml water plus 100 ml acetate buffer pH 4.6 for one hour, followed by filtering off the particulate matter. The di-nitro-salicylic acid solution is prepared as follows. (A) Dissolve 13.5 g NaOH pellets in 300 ml water. (B) Dissolve 8.8 g di-nitro-salicylic acid in 400 ml water at 60 degrees C., add 225 g KNa-tartrate dissolved in 400 ml water and mix. (C) Then mix the 300 ml NaOH solution with the di-nitro-salicylic acid/KNa-tartrate solution. (D) Prepare a solution incorporating 2.2 g NaOH pellets and 10 g 100% phenol in 100 ml of water and, additionally, a sulfite solution incorporating 37.5 g NaHSO3 in 100 ml water. To prepare the di-nitro-saliscylic acid working solution mix 69 ml of solution (D) with solution (C) and add 23.2 ml of the NaHSO3 solution. The mixture is ready for use 5 days after preparation.

The enzyme incubation is carried out by adding 1 ml of the CMC solution to 1 mL sample solution and incubate for 60 minutes at 37 degrees C. Terminate the reaction by adding 1 ml of NaOH 1 mol/l to 1 ml of the incubation mixture. Then add 3 ml of the di-nitro-salicylic acid working solution, mix and heat for 5 minutes in boiling water and, after cooling own, to the mixture 19 ml of water is added. Finally the absorbance at 540 nm is measured in a spectrophotometer.

### Amyloglucosidase Activity (AGI)

### Unit Definition

One Amyloglucosidase Unit (AGI) is the quantity of enzyme which will liberate 1 micromol glucose per minute under the conditions of the test.

### Assay

For determining the activity of amyloglucosidase the following reagents were prepared.

Starch substrate: 1.6 g of starch (Merck cat. No. 1252) was suspended in 10 mL of cold water. Subsequently this was poured into 50 mL of boiling water. After 2 minutes of boiling and cooling to room temperature 2 mL of acetic acid buffer (2 mol/L, pH 4.3) was added. The pH was checked and adjusted to pH 4.3 with 4 mol/L acetic acid or 4 mol/L NaOH, if necessary.
o-Anisidine Solution:

660 mg o-dianisidine-dihydrochloride (Sigma B3252) was dissolved in 100 mL water.

### Glucose Oxidase—Peroxidase Reagent:

5000 units glucose oxidase (Sigma G6125) and 1200 units peroxidase (Sigma P8125) were dissolved in 900 mL water. Consecutively 13.8 g disodium hydrogen phosphate 2 aq, 6.42 g sodium dihydrogen phosphate 1 aq and 6.10 g tris (hydroxy methyl)amino methane were added and dissolved. The pH of the solution was adjusted to 7.0 by adding phosphoric acid 100 g/L. After completing the volume to 1000 mL with water the solution was mixed again.

### Color Reagent

99 parts of Glucose oxidase—peroxidase reagent were mixed with 1 part of o-anisidine solution.

Assay: 2 mL sample mixed with 2 mL starch substrate was incubated at 60° C. for 15 minutes. The reaction was stopped by adding 20 mL 0.005 mol/L NaOH solution.

The glucose content was determined by mixing 1 mL of the incubate with 4 mL color reagent. After 10 minutes of incubation at 37° C. the reaction was stopped by adding 5 mL, 5 mol/L sulfuric acid. The absorbance was measured at 540 nm. The glucose content was calculated using a glucose calibration line with standards in the range of 25-150 μg/mL. The standards were directly colored with the color reagent.

### Example 1

### Production of the Lipases of the Invention

The lipolytic enzymes L01, L02, L03, L04 encoded by the nucleotide sequences SEQ ID NO:1 (DNA L01), SEQ ID NO: 3 (DNA L02), SEQ ID NO: 5 (DNA L03), SEQ ID NO: 7 (DNA L04) as provided herein were obtained by constructing expression plasmids containing the DNA sequences, transforming an Aspergillus niger strain with such plasmid and growing the A. niger strains in the following way.

Fresh spores (10⁶-10⁷) of A. niger strains were inoculated in 20 ml CSL-medium (100 ml flask, baffle) and grown for 20-24 hours at 34° C. and 170 rpm. After inoculation of 5-10 ml CSL pre-culture in 100 ml CSM medium (500 ml flask, baffle) the strains were fermented at 34° C. and 170 rpm for 3-5 days.

Cell-free supernatants were obtained by centrifugation of the fermentation broth at 5000×g for 30 minutes at 4° C. The cell-free supernatants are stored at −20° C. until use. Optionally the supernatant can be filtered further over a GF/A Whatmann Glass microfiber filter (150 mm \acute{Ø}) to remove the larger particles. If necessary the pH of the supernatant is adjusted to pH 5 with 4 N KOH and sterile filtrated over a 0.2 μm (bottle-top) filter with suction to remove the fungal material.

The CSL medium consisted of (in amount per litre): 100 g Corn Steep Solids (Roquette), 1 g NaH₂PO4*H₂O, 0.5 g MgSO₄*7H₂O, 10 g glucose*H₂O and 0.25 g Basildon (antifoam). The ingredients were dissolved in demi-water and the pH was adjusted to pH 5.8 with NaOH or H₂SO₄; 100 ml flasks with baffle and foam ball were filled with 20 ml fermentation broth and sterilized for 20 minutes at 120° C. after which 200 μl of a sterile solution containing 5000 IU/ml penicillin and 5 mg/ml Streptomycin was added to each flask after cooling to room temperature.

The CSM medium consisted of (in amount per litre): 150 g maltose*H2O, 60 g Soytone (pepton), 1 g NaH₂PO4*H₂O, 15 g MgSO₄*7H₂O, 0.08 g Tween 80, 0.02 g Basildon (antifoam), 20 g MES, 1 g L-arginine. The ingredients were dissolved in demi-water and the pH was adjusted to pH 6.2 with NaOH or H₂SO₄; 500 ml flasks with baffle and foam ball were filled with 100 ml fermentation broth and sterilized for 20 minutes at 120° C. after which 1 ml of a sterile solution containing 5000 IU/ml penicillin and 5 mg/ml Streptomycin was added to each flask after cooling to room temperature.

### Example 2

### Purification of the Lipolytic Enzyme of the Invention

After thawing of the frozen cell-free supernatants obtained in example 1 the supernatants were centrifuged extensively at 4° C. to remove any solids. In order to remove low molecular weigth contaminations the supernatants were ultrafiltrated using a Millipore Labscale TFF system equipped with a filter with a 10 kDa cut-off. The samples were washed 3-5 times with 40 ml volumes of cold 100 mM phosphate buffer pH 6.0 including 0.5 mM CaCl₂. The final volume of the enzyme solution was 30 ml and is further referred to as “ultrafiltrate”.

For further purification the ultrafiltrate can be applied to a MonoQ anion exchange column. The salt gradient was set to 1M NaCL over 20 column volumes. Buffers were a mixture of 70 mM Bis-TRIS and 50 mM TRIS. The pH was set with 0.1M HCl. Surprisingly it was observed that best results were obtained when the purification was performed at pH=9, where the lipase elutes at a conductivity of 35 mS/cm.

Total protein content of the samples was determined using the Bradford method (The Protein Protocols Handbook, 2^{nd} edition, Edited by J. M. Walker, Humana Press Inc, Totowa 2002, p 15-21).

### Example 3

### Baking Experiment

### Dutch Tin Bread

### Effect of a Composition Comprising L01, Triacyl Glycerol Lipase, Cellulase and Amyloglucosidase on Dough and Bread Properties

Dutch tin bread was prepared as follows. 3500 g of flour (2800 g Kolibri+700 g Ibis), 58% w/w of water based on flour, 80 g compressed yeast, 90 g of bread improver (comprising 35% Enzyme active Soya flour, 30% flour, 18% whey powder, 7% oil, 10% dextrose), 70 g of salt (NaCl), 40 ppm ascorbic acid (based on flour weight), 7 ppm (based on flour weight) Bakezyme P500 (fungal α-amylase), 20 ppm (based on flour weight) Bakezyme HSP6000 (fungal hemicellulase) and various enzymes or SSL as indicated in table 1 were mixed on a Diosna mixer for 2 minutes at speed 1 and 125 kWh at speed 2, to a final dough temperature of ˜28° C. Dough pieces of 880 g were rounded and proofed for 40 minutes at 34° C. and 85% relative umidity. Subsequently the dough pieces were molded, shaped, panned and proofed for 75 minutes, 38° C. and 85% relative humidity (R.H.). The fully proofed doughs where baked in an oven at 265° C. for 30 minutes.

After cooling down to room temperature the volumes of the loaves were determined by an automated bread volume analyser (BVM-3, TexVol Instruments). The loaf volume of the blank bread is defined as 100%. Further effects were evaluated manually and visually by an experienced baker as indicated in Table 2.

TABLE 1
Amounts of further enzymes or SSL used in the experiments

| Enzymes | Exp. 1, 5 | | | |
|---|---|---|---|---|
| or SSL | (control) | Exp. 2, 6 | Exp. 3, 7 | Exp. 4, 8 |
| SSL | — | 0.5% | — | — |
| L01 | — | — | 35.75 DLU/kg | 28.6 DLU/kg |
| | | | flour | flour |
| Bakezyme | — | — | 1300 AGI/kg | 1040 AGI/kg |
| AG800 | | | flour | flour |
| Bakezyme | — | — | 800 PLI/kg | 640 PLI/kg |
| L80000 | | | flour | flour |
| Bakezyme | — | — | 23.4 CXU/kg | 18.72 CXU/kg |
| X-Pan | | | flour | flour |

### Further Enzymes:

Lipolytic enzyme L01 was obtained and purified as indicated in example 1 and 2. The activity of the purified sample was determined in DLU unit per gram of Bradford protein using the assay indicated under Materials and Methods. Bakezyme AG800 is an amyloglucosidase derived from Aspergillus niger. Bakezyme L80000 is a triacyl glycerol lipase derived from Rhyzopus oryzae. Bakezyme X-Pan is a cellulase derived from Aspergillus niger.

TABLE 2
Scores for effects observed in Dutch tin bread

| | Score | | | | |
|---|---|---|---|---|---|
| Effect | 1 | 2 | 3 | 4 | 5 |
| Dough | very sticky | sticky | normal | dry | excellent |
| stickiness | | | | | dry |
| Dough | Very short | shorter | Control | Good | too |
| extensibility | | than | bread | | extensible |
| | | control | | | |
| Crumb | poor | reasonable | good | very good | excellent |
| softeness | | | | | |

In a first set of experiments (Experiments 1 to 4) dough and baked products were prepared as indicated above.

Results of the evaluation of the doughs and baked products obtained from the doughs is indicated in Table 3.

TABLE 3

| | Exp. 1 | | | |
|---|---|---|---|---|
| | (control) | Exp. 2 | Exp. 3 | Exp. 4 |
| Volume % | 100 | 104 | 108 | 109 |
| Baked prod. | | | | |
| Dough | 3 | 4 | 4 | 4 |
| extensibility | | | | |
| Dough | 2 | 3 | 3 | 3 |
| stickiness | | | | |
| Crumb | 1 | 3 | 3 | 3 |
| softness¹ | | | | |

¹Crumb softness was determined after 24 hours

The results in table 3 show that the doughs and bread prepared using a baking enzyme composition according to the invention (Exp. 3, 4) are able to improve dough properties such as e.g. dough extensibility and stickeness, bread volume and crumb softness. These improvements are comparable to those obtained by using the emulsifier SSL (Exp. 2). The volume of the baked product obtained from a dough comprising a baking composition according to the invention is actually improved if compared with a baked product obtained from a dough containing emulsifier SSL. These results show that the baking enzyme composition according to the invention can fully replace SSL in the preparation of soft bread such as Dutch tin bread.

In a second set of experiments (experiments 5 to 8) the doughs were prepared as indicated above with the difference that the dough was shocked prior to baking. Shocking of the dough was performed by subjecting the fully proofed dough contained in a baking tin to a fall of 20 cm and by baking it as indicated above. Results of the evaluation of the baked products obtained from the doughs is indicated in Table 4.

TABLE 4

| | Exp. 5 | | | |
|---|---|---|---|---|
| | (control) | Exp. 6 | Exp. 7 | Exp. 8 |
| Volume % | 78 | 98 | 104 | 106 |
| baked prod. | | | | |

The results indicate that a bread prepared without using emulsifier and obtained from a dough which was shocked has lost more than 20% of its volume. This indicates that the dough from which it was prepared has a low shock resistance. A bread prepared from a dough which was shocked under the same conditions and which comprises SSL has approximately the same volume of a bread obtained by a dough which does not comprises emulsifiers and it has not been shocked. A bread obtained from a dough which was shocked under the same conditions and comprises a baking composition according to the invention still has an improved volume if compared with a bread obtained by a dough which does not comprises emulsifiers and it has not been shocked (corresponding to Volume % 100), not shown in table 4). This bread ha also a better volume in respect with the bread of experiment 6 obtained from a dough comprising SSL and which was shocked. This indicates the excellent shock resistance of a dough comprising a baking composition according to the invention, which is even better than the shock resistance of a dough comprising SSL as an emulsifier.

### Example 4

### Baking Experiment

### Standard Batard

### Effect of a Composition Comprising Lipolytic Enzyme L01 and a Triacyl Glycerol Lipase on Dough and Bread Properties

Standard batard bread was prepared as follows. 3000 g of flour (2700 g Kolibri+300 g Ibis), 58% w/w of water (based on flour), 70 g compressed yeast, 60 g of salt (NaCl), 34 ppm (based on flour weight) ascorbic acid, 3 ppm (based on flour weight) Bakezyme P500 (fungal α-amylase), 15 ppm (based on flour weight) Bakezyme HSP6000 (fungal hemicellulase) and enzymes as indicated in table 5 were mixed on a Diosna mixer for 2 minutes at speed 1 and 105 kWh at speed 2, to a final dough temperature of ˜27° C. Dough pieces of 350 g were rounded and proofed for 40 minutes at 32° C. and 90% relative umidity. Subsequently the dough pieces were molded and shaped and proofed for 100 minutes, 32° C. and 90% R.H. The fully proofed doughs were baked in an oven at 280° C. for 7 minutes and at 265-270° C. for 28 minutes.

After cooling down to room temperature the volumes of the loaves were determined as indicated in Example 3. Dough elasticity, dough stability and crumb structure of the baked product were evaluated visually by an experienced baker.

TABLE 5

| | Experiment 1 | Experiment 2 |
|---|---|---|
| Enzymes | L01: 41.25 DLU/kg flour | |
| | Triacyl glycerol lipase | Triacyl glycerol |
| | from Rhyzopus | lipase from |
| | oryzae: | Rhyzopus oryzae: |
| | 0 PLI/kg flour | 800 PLI/kg flour |
| Dough elasticity | 3 (good) | 4 (very good) |
| Dough stability | 3 (good) | 3 (good) |
| Bread volume (ml)/% | 1834 ml/100% | 1800 ml/98% |
| Crumb structure | Slightly open | Fine |

The experiment shows that when a composition according to the invention comprising lipolytic enzyme L01 and a triacyl glycerol lipase is used in the production of batard a dough with good stability and improved elasticity is obtained and the corresponding baked product has a finer crumb structure and comparable bread volume when compared with a baked product produced by using only the lipolytic enzyme L01.

### Example 5

### Baking Experiment

### Standard Batard

Effect of a Composition Comprising Lipolytic Enzyme L01 and a Triacvl Glycerol Lipase in Comparison with a Prior Art Lipolytic Enzyme on Bread and Dough Property

Standard batard bread was prepared as indicated in example 4 with the only difference that mixing of the ingredients at speed 2 was effected at 71 kWh instead of 105 kWh. The following ingredients were used:

2000 g of flour (1800 g Kolibri+200 g Ibis), 58% w/w of water (based on flour), 47 g compressed yeast, 40 g of salt (NaCl), 44 ppm ascorbic acid (based on kg of flour), 3 ppm (based on kg of flour) Bakezyme P500 (fungal α-amylase), 15 ppm (based on kg of flour) Bakezyme HSP6000 (fungal hemicellulase) and enzymes as indicated in table 6.

TABLE 6

| | Experiment 1 | Experiment 2 | Experiment 3 |
|---|---|---|---|
| Enzymes | LipopanF¹: | LipopanF¹: | L01: |
| | 20 ppm (based | 30 ppm (based on | 15 ppm (based on |
| | on flour) | flour) | flour) |
| | | | Piccantase A²: |
| | | | 15 ppm (based on |
| | | | flour |
| Dough | 3 (good) | 3 (good) | 4 (very good) |
| extensibility | | | |
| Dough | 3 (good) | 3 (good) | 3 (good) |
| elasticity | | | |
| Bread volume % | 100% | 101% | 103% |

¹Lipopan F: lipolytic enzyme from Fusarium oxysporum described in WO98/26057 with activity on phospholipids, triglycerides and galactolipids (Novozymes - Denmark).
²Piccantase A: a triacyl glycerol lipase from Rhyzomucor miehei (DSM Food Specialties - the Netherlands).

Bread volume was measured as in Example 3. Dough extensibility, dough elasticity of the baked product were evaluated visually by an experienced baker. The experiment shows that when a composition according to the invention comprising a lipolytic enzyme L01 and a triacyl glycerol lipase is used in the production of batard, a dough with good stability and improved elasticity is obtained and the corresponding baked product has an improved volume if compared with the dough and baked product obtained by using a prior art lipolytic enzyme with activity on phospholipids, triglycerides and galactolipids.

### Example 6

### Baking Experiment

### Dutch Tin Bread

Effect of a Composition Comprising Lipolytic Enzyme L01, Triacyl Glycerol Lipases, and Cellulase in Comparison with a Composition Comprising L01 and Triacyl Glycerol Lipases on Bread and Dough Property

Dutch tin was prepared as indicated in example 3 with the exception that first proof occurred at 34° C. and 85% R.H. for 35 minutes, second proof at 38° C., 85% R.H. for 70 minutes and baking of the fully proofed doughs occurred at 280° C. for 7 minutes and at 265-270° C. for 28 minutes. The following ingredients were used: 3500 g of flour (2800 g Kolibri+700 g Ibis), 58% w/w (based on flour) of water, 77 g compressed yeast, 70 g of salt (NaCl), 35 g sugar, 35 g fat, 40 ppm (based on flour weight) ascorbic acid, 3 ppm (based on flour weight) Bakezyme P500 (fungal α-amylase), 15 ppm (based on flour weight) Bakezyme HSP6000 (fungal hemicellulase), 10 ppm (based on flour weight) Bakezyme MA 10000 (anti staling amylase) and various enzymes as indicated in table 7.

Volume of the baked product was measured as indicated in Example 3 while softness was determined empirically by an experienced baker.

TABLE 7

| | Experiment 1 | Experiment 2 |
|---|---|---|
| Enzymes | LipopanF: | L01: |
| | 13 ppm (based on flour) | 13 ppm (based on flour) |
| | | (=35.75 DLU/kg of flour) |
| | Triacyl glycerol lipase from Rhyzopus oryzae: | |
| | 800 PLI/kg flour | |
| | Cellulase from Trichoderma reesei: 255 CXU/kg flour | |
| Bread softness¹ | + (good) | +++ (excellent) |
| Bread volume % | 100% | 100% |

¹Bread softness was determined after 24 hours.

The experiment clearly shows that a composition of the invention when used in the production of soft tin bread considerably improves the softness of the bread. The improvement is expecially evident when the lipolytic enzyme L01 is used in the composition.

### Example 7

### Baking Experiment

### Dutch Tin Bread

Effect of a Composition Comprising Lipolytic Enzyme L01, a Triacvl Glycerol Lipase and a Cellulase in Comparison with a Composition Comprising Lipolytic Enzyme L01 and a Triacyl Glycerol Lipase

Dutch tin bread was prepared as follows. 3500 g of flour (2800 g Kolibri+700 g lbis), 58% w/w (based on flour) of water, 80 g compressed yeast, 87.5 g of bread improver (comprising 35% Enzyme active Soya flour, 30% flour, 18% whey powder, 7% oil, 10% dextrose), 70 g of salt (NaCl), 40 ppm (based on flour weight) ascorbic acid (based on kg of flour), 10 ppm (based on flour weight) Bakezyme P500 (fungal α-amylase), 20 ppm (based on flour weight) Bakezyme HSP6000 (fungal hemicellulase), 10 ppm (based on flour weight) of Bakezyme MA 10000 (anti staling amylase) and various enzymes as indicated in table 8 were mixed on a Diosna mixer for 3 minutes at speed 1 and 130 kWh at speed 2, to a final dough temperature of 28° C. Dough pieces of 875 g were rounded and proofed for 5 minutes at room temperature; subsequently they were molded, shaped and proofed at room temperature for 15 minutes. Subsequently the dough pieces were molded, shaped, panned and proofed for 70 minutes, 38° C. and 85% R.H. The fully proofed doughs where baked in a hoven at 280° C. for 7 minutes and at 265-270° C. for 28 minutes.

Dough characteristics and bread volume were determined as indicated in Example 3. The results are reported in Table 8.

TABLE 8

| | Experiment 1¹ | Experiment 2² |
|---|---|---|
| Enzymes | L01: 35.75 DLU/kg flour | |
| | Triacyl glycerol lipase from Rhyzopus oryzae: | |
| | 800 PLI/kg flour | |
| | Cellulase from | Cellulase from |
| | Trichoderma reesei: | Trichoderma reesei: |
| | 0 CXU/kg flour | 250 CXU/kg flour |
| Dough | + | ++ |
| extensibility | | |
| Dough elasticity | + | ++ |
| Dough stickiness | + | 0 |
| Bread volume % | 100% | 98% |

From a comparison of experiment 1 and 2 it is evident that a composition according to the invention comprising L01, a triacyl glycerol lipase and a cellulase (Experiment 2) improves dough characteristics such as extensibility and elasticity and reduces dough stickiness when added to bread dough in an effective amount if compared with a composition according to the invention which does not comprises cellullase.

### Example 8

### Baking Experiment

### Dutch Tin Bread

Effect of a Composition Comprising Lipolytic Enzyme L01, a Triacyl Glycerol Lipase, a Cellulase and an Aminoglucosidase in Comparison with a Composition Comprising Lipolytic Enzyme L01, a Macyl Glycerol Lipase and a Cellulase

Dutch tin bread was prepared as indicated in Example 7 with the exception that the mixing was performed for 3 minutes at speed 1 and 120 kWh at speed 2. The dough pieces (750 g) were proofed for 35 minutes at 32° C. at 85% R.V. and subsequently for 70 minutes and under the same conditions.

The ingredients used were: 3000 g of flour (2400 g Kolibri+600 g Ibis), 58% w/w (based on flour) of water, 60 g compressed yeast, 75 g of bread improver (comprising 35% Enzyme active Soya flour, 30% flour, 18% whey powder, 7% oil, 10% dextrose), 60 g of salt (NaCl), 40 ppm (based on flour weight) ascorbic acid (based on kg of flour), 7 ppm (based on flour weight) Bakezyme P500 (fungal α-amylase), 20 ppm (based on flour weight) Bakezyme HSP6000 (fungal hemicellulase), 10 ppm (based on flour weight) of Bakezyme MA 10000 (anti staling amylase) and various enzymes as indicated in table 9.

Dough characteristics and bread volume were determined as indicated in Example 3. The results are reported in Table 9.

TABLE 9

| | Experiment 1 | Experiment 2 |
|---|---|---|
| Enzymes | L01: 35.75 DLU/kg flour | |
| | Triacyl glycerol lipase from Rhyzopus oryzae: | |
| | 800 PLI/kg flour | |
| | Triacyl glycerol lipase from Humicola lanuginosa¹: | |
| | 302 PLI/kg flour | |
| | Cellulase from Aspergillus niger: | |
| | 23.4 CXU/kg flour | |
| | Amiloglucosidase from | Amiloglucosidase from |
| | Aspergillus niger: | Aspergillus niger: |
| | 0 AGI/kg flour | 1300 AGI/kg flour |
| Dough | ++ | +++ |
| extensibility | | |
| Dough elasticity | +++ | +++ |
| Dough stickiness | 0 | 0 |
| Crumb structure | fine | Finer than 1 |
| Bread volume % | 100% | 98.1% |

¹Humicola lanuginosa is also indicated as Thermomyces lanuginosus

From a comparison of experiment 1 and 2 it is evident that a composition according to the invention comprising L01, triacyl glycerol lipases, a cellulase and amyloglucosidase (Experiment 2) further improves dough characteristics such as extensibility, elasticity when added to bread ingredients in an effective amount and yields a baked product with even a finer crumb structure if compared with a composition according to the invention which does not comprises amyloglucosidase (experiment 1).

### Example 9

### Baking Experiment

### Dutch Tin Bread

Effect of a Composition Comprising Lipolytic Enzyme L01, Triacyl Glycerol Lipases, a Cellulase and an Aminoglucosidase on Dough Characteristics and Bread Volume and Softness in Comparison with GMS or SSL

Dutch tin bread was prepared as indicated in Example 7 with the exception that the mixing was performed for 4 minutes at speed 1 and 112 kWh at speed 2. The dough pieces (840 g) were proofed for 40 minutes at 30° C. at 70% R.V. and subsequently for 70 minutes at 38° C. at 90% R.V.

The ingredients used were: 3000 g of flour (2400 g Kolibri+600 g Ibis), 58% w/w (based on flour) of water, 75 g compressed yeast, 60 g of salt (NaCl), 90 g shortening, 45 g sugar, 20 ppm (based on flour weight) L-cysteine, 30 ppm (based on flour weight) ascorbic acid (based on kg of flour), 7.8 ppm (based on flour weight) Bakezyme P500 (fungal α-amylase), 17.5 ppm (based on flour weight) Bakezyme HSP6000 (fungal hemicellulase), and various enzymes, SSL or GMS as indicated in table 10.

Bread volumes were determined as indicated in Example 3. Crumb fiminess was measured after 24 hours with a texture analyser TA-TX Plus. The results for bread volume and crumb firminess are reported in Table 11.

TABLE 10

| Enzymes, GMS | | | | |
|---|---|---|---|---|
| or SSL | Exp. 1 | Exp. 2 | Exp. 3 | Exp. 4 |
| SSL | — | — | 12 ppm | — |
| GMS | — | 15 ppm | | — |
| L01 | — | — | — | 35.75 DLU/kg |
| | | | | flour |
| Amyloglucosidase from | — | — | — | 1300 AGI/kg |
| A. niger | | | | flour |
| Triacyl glycerol lipase | — | — | — | 800 PLI/kg |
| from R. oryzae | | | | flour |
| Triacyl glucerol lipase | — | | | 302 PLI/kg |
| from H. lanuginosa | | | | flour |
| Cellulase from T. reesei | — | — | — | 75 CXU/kg |
| | | | | flour |

TABLE 11

| | Exp. 1 | Exp. 2 | Exp. 3 | Exp. 4 |
|---|---|---|---|---|
| Volume % | 100 | 98 | 100 | 101 |
| Baked prod. | | | | |
| Crumb | 478 | 397.5 | 335 | 333 |
| firminess | | | | |
| (g) | | | | |

The results in table 11 show that bread prepared using a baking enzyme composition according to the invention (Exp. 4) has improved crumb softness in a way comparable to bread containing SSL (Exp. 3) and superior to bread containing GMS (Exp. 2). The volume of the baked product obtained from a dough comprising a baking composition according to the invention is actually slightly improved if compared with a baked product obtained from a dough containing emulsifier SSL or GMS. These results show that the baking enzyme composition according to the invention can fully replace SSL or GMS in the preparation of soft bread such as Dutch tin bread.

1. A baking enzyme composition comprising a lipolytic enzyme which is an isolated polypeptide comprising:
(a) an amino acid sequence according to a mature polypeptide derived from the amino acid sequence according to SEQ ID NO: 2 or a functional equivalent thereof having an amino acid sequence at least 80 or 90% homologous to the mature polypeptide derived from the amino acid sequence according to SEQ ID NO: 2; OR
(b) an amino acid sequence encoded by a polynucleotide which comprises:
(a) the nucleotide sequence as set out in SEQ ID NO: 1 or a functional equivalent thereof having at least 80 or 90% homology to the nucleotide sequence of SEQ ID NO: 1; OR
(b) a nucleotide sequence which hybridizes with a polynucleotide being the complement of SEQ ID NO: 1 and wherein said nucleotide sequence is at least 80 or 90% homologous to the nucleotide sequence of SEQ ID NO: 1; OR
(c) a nucleotide sequence encoding the mature polypeptide derived from the amino acid sequence according to SEQ ID NO: 2 or a functional equivalent thereof having at least 80 or 90% homology to the mature polypeptide in the amino acid sequence of SEQ ID NO: 2; OR
(d) a sequence which is degenerate as a result of degeneracy of genetic code to a sequence as defined in any one of (a), (b), (c); OR
(e) a nucleotide sequence which is the complement of a nucleotide sequence as defined in (a), (b), (c), or (d);
and wherein the composition further comprises a triacyl glycerol lipase.

2. The baking enzyme composition according to claim 1, comprising a hemicellulose or cellulose.

3. The baking enzyme composition according to claim 1 comprising an amyloglucosidase.

4. The baking enzyme composition according to claim 1, comprising a combination of at least two triacyl glycerol lipases.

5. A pre-mix comprising said baking enzyme composition according to claim 1, and at least one of flour and/or a dough and/or a bread additive.

6. A method to prepare a dough comprising adding said baking enzyme composition according to claim 1 to at least one dough ingredient comprising flour, water and/or yeast.

7. A dough comprising flour, water, yeast and an effective amount of said baking enzyme composition according to claim 1.

8. A dough according to claim 7, comprising at least 3.57 DLU units per kg of flour of lipolytic enzyme, optionally at least 7.15 DLU/kg flour and optionally comprising at most 143 DLU/kg flour of lipolytic enzyme.

9. A dough according to claim 7, comprising at least 80 PLI units per kg of flour of triacyl glycerol lipase, optionally at least 160 PLI/kg flour, and optionally comprising at most 3200 PLI/kg flour of triacyl glycerol lipase.

10. A dough according to claim 7, comprising at least 2.34 CXU units per kg of flour of cellulase, optionally at least 4.68 CXU/kg flour, and optionally comprising at most 300 CXU/kg of flour of cellulase.

11. A dough according to claim 7, comprising at least 130 AGI units per kg of flour of amyloglucosidase, optionally at least 260 AGI/kg flour, and optionally comprising at most 5200 AGI/kg flour of amyloglucosidase.

12. A dough according to claim 7 which is substantially free of SSL and/or CSL.

13. A method to prepare a baked product comprising baking said dough according to claim 7.

14. A baked product obtainable by baking said dough according to claim 7.

15. The baking enzyme composition according to claim 1, which is capable of being used to replace an emulsifier, and optionally to replace SSL in the production of a dough or baked product derived therefrom.

16. The pre mix according to claim 5, which is capable of being used to replace an emulsifier and optionally to replace SSL in the production of a dough or a baked product derived therefrom.


SEQUENCE LISTING (8 sequences)

SEQ ID NO: 1 - DNA, 1038 bp, Artificial Sequence
  DNA L01 lipase gene
atgcttctcctctccctcctctccattgtcaccctcgctgttgcttctcctctgtccgttgaggagtacgccaaggccctcgaggagcgtgccgtcaccgtctcctcctccgagctcaacaacttcaagttctacatccagcacggtgctgctgcctactgcaactccgagactgctgctggtgccaacgtcacctgcactggcaacgcctgccccgagattgaggccaacggtgtcaccgttgttgcctccttcactggtaccaagactggtatcggtggctacgtctccaccgacaacaccaacaaggagatcgtcctttctttccgtggcagcatcaacatccgcaactggctgaccaacctggacttcggccaggatgactgctctctgacctccggctgcggtgtccactccggtttccagcgtgcctgggaggagattgccgacaacctgaccgctgctgttgccaaggccaagactgccaaccccgactacaaggttgttgccactggccactccctgggtggtgctgttgccaccctggctggtgccaacctccgtgctgctggtacccccctcgacatctacacctacggctctccccgtgtcggcaacgccgagcttgctgagttcatctccaaccagactggtggtgagttccgtgtcacccacggtgatgaccccgtcccccgtcttcctcctctgatcttcggctaccgccacacctcccccgagtactggctcgatggcagcggtggtgacaagatcaactacaccatcaacgacatcaaggtctgcgagggtgctgccaacctgcagtgcaacggtggtaccctgggtctcgacattgctgctcacctgcactacttccaggccactgatgcctgcaacgccggtggtttcagctggcgccgctaccgctctgctgagagcgttgacaagcgtgccaccatgactgatgctgagctcgagaagaagctcaacagctacgtgcagatggacaaggagtacgtcaagaacaaccaggctcgctcc

SEQ ID NO: 2 - protein, 346 aa, Artificial Sequence
  L01 lipase protein
MLLLSLLSIVTLAVASPLSVEEYAKALEERAVTVSSSELNNFKFYIQHGAAAYCNSETAAGANVTCTGNACPEIEANGVTVVASFTGTKTGIGGYVSTDNTNKEIVLSFRGSINIRNWLTNLDFGQDDCSLTSGCGVHSGFQRAWEEIADNLTAAVAKAKTANPDYKVVATGHSLGGAVATLAGANLRAAGTPLDIYTYGSPRVGNAELAEFISNQTGGEFRVTHGDDPVPRLPPLIFGYRHTSPEYWLDGSGGDKINYTINDIKVCEGAANLQCNGGTLGLDIAAHLHYFQATDACNAGGFSWRRYRSAESVDKRATMTDAELEKKLNSYVQMDKEYVKNNQARS

SEQ ID NO: 3 - DNA, 1038 bp, Artificial Sequence
  DNA L02 lipase gene
atgcttctcctctccctcctctccattgtcaccctcgctgttgcttctcctctgtccgttgaggagtacgccaaggccctcgaggagcgtgccgtcaccgtctcctcctccgagctcaacaacttcaagttctacatccagcacggtgctgctgcctactgcaactccgagactgctgctggtgccaaggtcacctgctccaacaacggctgccccgaggttgaggccaacggtgtcaccgttgttgcctccttcgtcggtaccaagaccggtatcggtggctacgtggccaccgacaacgcccgcaaggagatcgtcctctccttccgtggcagcatcaacatccgcaactggctgaccaacctggacttcggccaggaggactgctctctgacctccggctgcggtgtccactccggtttccagcgtgcctgggaggagattgccgacaacttgactgctgctgttgccaaggccaagactgccaaccccgactacaaggtcgtcagcactggccactctcttggtggtgctgttgccaccctggctgctgccaacctccgtgtcggtggtactcctcttgacatctacacctacggctctccccgtgtcggcaacgccgagctctccgctttcgtctccaaccagactggtggtgagttccgtgtcacccacggtgatgaccccgtcccccgtcttcctcctctgatcttcggctaccgccacacctcccccgagtactggctcgatggcagcggtggtgacaaggtcgactacaccatcaacgacatcaaggtctgcgagggtgctgccaacctgcagtgcaacggtggtaccctgggtctcgacattgctgctcacctgcactacttccaggccactgatgcctgcaacgccggtggtttcagctggcgccgctaccgctctgctgagagcgttgacaagcgtgccaccatgactgatgctgagctcgagaagaagctcaacagctacgtgcagatggacaaggagtacgtcaagaacaaccaggctcgctcc

SEQ ID NO: 4 - protein, 346 aa, Artificial Sequence
  L02 lipase protein
MLLLSLLSIVTLAVASPLSVEEYAKALEERAVTVSSSELNNFKFYIQHGAAAYCNSETAAGAKVTCSNNGCPEVEANGVTVVASFVGTKTGIGGYVATDNARKEIVLSFRGSINIRNWLTNLDFGQEDCSLTSGCGVHSGFQRAWEEIADNLTAAVAKAKTANPDYKVVSTGHSLGGAVATLAAANLRVGGTPLDIYTYGSPRVGNAELSAFVSNQTGGEFRVTHGDDPVPRLPPLIFGYRHTSPEYWLDGSGGDKVDYTINDIKVCEGAANLQCNGGTLGLDIAAHLHYFQATDACNAGGFSWRRYRSAESVDKRATMTDAELEKKLNSYVQMDKEYVKNNQARS

SEQ ID NO: 5 - DNA, 1038 bp, Artificial Sequence
  DNA L03 lipase gene
atgcttctcctctccctcctctccattgtcaccctcgctgttgcttctcctctgtccgttgaggagtacgccaaggccctcgaggagcgtgccgtcaccgtctcctcctccgagctcaacaacttcaagttctacatccagcacggtgctgctgcctactgcaactccgagactgctgctggtgccaaggtcacctgctctggcaacggctgccccgaggttgaggccaacggtgtcaccgttgttgcctccttcaccggtaccaagaccggtatcggtggctacgtggccaccgacaacgcccgcaaggagatcgtcctctccttccgtggcagcatcaacatccgcaactggctgaccaacctggacttcggccaggatgactgctctctgacctccggctgcggtgtccactccggtttccagcgtgcctgggaggagattgccgacaacttgactgctgctgttgccaaggccaagactgccaaccccgactacaaggtcgtcgccactggccactccctgggtggtgctgttgccaccctggctggtgccaacctccgtgtcggtggtactcctcttgacatctacacctacggctctccccgtgtcggcaacgccgagcttgctgctttcgtctccaaccagactggtggtgagttccgtgtcacccacggtgatgaccccgtcccccgtcttcctcctctgatcttcggctaccgccacacctcccccgagtactggctcgatggcagcggtggtgacaagatcgactacaccatcaacgacatcaaggtctgcgagggtgctgccaacctgcagtgcaacggtggtaccctgggtctcgacattgctgctcacctgcactacttccaggccactgatgcctgcaacgccggtggtttcagctggcgccgctaccgctctgctgagagcgttgacaagcgtgccaccatgactgatgctgagctcgagaagaagctcaacagctacgtgcagatggacaaggagtacgtcaagaacaaccaggctcgctcc

SEQ ID NO: 6 - protein, 346 aa, Artificial Sequence
  L03 lipase protein
MLLLSLLSIVTLAVASPLSVEEYAKALEERAVTVSSSELNNFKFYIQHGAAAYCNSETAAGAKVTCSGNGCPEVEANGVTVVASFTGTKTGIGGYVATDNARKEIVLSFRGSINIRNWLTNLDFGQDDCSLTSGCGVHSGFQRAWEEIADNLTAAVAKAKTANPDYKVVATGHSLGGAVATLAGANLRVGGTPLDIYTYGSPRVGNAELAAFVSNQTGGEFRVTHGDDPVPRLPPLIFGYRHTSPEYWLDGSGGDKIDYTINDIKVCEGAANLQCNGGTLGLDIAAHLHYFQATDACNAGGFSWRRYRSAESVDKRATMTDAELEKKLNSYVQMDKEYVKNNQARS

SEQ ID NO: 7 - DNA, 1038 bp, Artificial Sequence
  DNA L04 lipase gene
atgcttctcctctccctcctctccattgtcaccctcgctgttgcttctcctctgtccgttgaggagtacgccaaggccctcgaggagcgtgccgtcaccgtctcctcctccgagctcaacaacttcaagttctacatccagcacggtgctgctgcctactgcaactccgagactgctgctggtgccaacgtcacctgctctggcaacggctgccccgaggttgaggccaacggtgtcaccgttgttgcctccttcaccggtaccaagaccggtatcggtggctacgtcgccaccgacaacgcccgcaaggagatcgtcctctccttccgtggcagcatcaacatccgcaactggctgaccaacctggacttcggccaggatgactgctctctgacctccggctgcggtgtccactccggtttccagcgtgcctgggaggagattgccgacaacttgactgctgctgttgccaaggccaagactgccaaccccgactacaaggttgttgccactggccactctcttggtggtgctgttgccactctggctggtgccaacctccgtgtcggtggtacccccctcgacatctacacctacggctctcctcgtgtcggcaacgccgagcttgctgctttcgtctccaaccaggctggtggtgagttccgtgtcacccacggtgatgaccccgtcccccgtcttcctcctctgatcttcggctaccgccacacctcccccgagtactggctcgatggcagcggtggtgacaagatcgactacaccatcaacgacatcaaggtctgcgagggtgctgccaacctgcagtgcaacggtggtaccctgggtctcgacattgctgctcacctgcactacttccaggccactgatgcctgcaacgccggtggtttcagctggcgccgctaccgctctgctgagagcgttgacaagcgtgccaccatgactgatgctgagctcgagaagaagctcaacagctacgtgcagatggacaaggagtacgtcaagaacaaccaggctcgctcc

SEQ ID NO: 8 - protein, 346 aa, Artificial Sequence
  L04 lipase protein
MLLLSLLSIVTLAVASPLSVEEYAKALEERAVTVSSSELNNFKFYIQHGAAAYCNSETAAGANVTCSGNGCPEVEANGVTVVASFTGTKTGIGGYVATDNARKEIVLSFRGSINIRNWLTNLDFGQDDCSLTSGCGVHSGFQRAWEEIADNLTAAVAKAKTANPDYKVVATGHSLGGAVATLAGANLRVGGTPLDIYTYGSPRVGNAELAAFVSNQAGGEFRVTHGDDPVPRLPPLIFGYRHTSPEYWLDGSGGDKIDYTINDIKVCEGAANLQCNGGTLGLDIAAHLHYFQATDACNAGGFSWRRYRSAESVDKRATMTDAELEKKLNSYVQMDKEYVKNNQARS